(19) United States
(12) Patent Application Publication
(10) Pub. No.: US 2026/0172634 A1
(43) Pub. Date: Jun. 18, 2026

(54) SYSTEMS, METHODS, APPARATUSES, AND COMPUTER-READABLE MEDIA FOR CONTEXT-AWARE MODIFICATION OF MEDIA CONTENT DURING DEVICE CASTING

(71) Applicant: Adeia Guides Inc., San Jose, CA (US)

(72) Inventors: Charles Dasher, Lawrenceville, GA (US); Reda Harb, Saint Petersburg, FL (US); Jean-Yves Couleaud, Mission Viejo, CA (US); Dhananjay Lal, Englewood, CO (US); Christopher Phillips, Hartwell, GA (US)

(21) Appl. No.: 18/981,093

(22) Filed: Dec. 13, 2024

(51) Int. Cl. H04N 21/472; G06F 3/14; H04N 21/414; H04N 21/4363; H04N 21/4627

(52) U.S. Cl. CPC H04N 21/47205; G06F 3/1454; H04N 21/41415; H04N 21/43637; H04N 21/4627

(57) ABSTRACT

Systems, methods, apparatuses, and computer-readable media are described for presenting, via a device, an initial output of a content item, wherein the content item is associated with a content provider; identifying a characteristic of the device; determining, based on the identified characteristic, a privacy level of an environment of the device; and based at least in part on the determined privacy level, presenting, via the device, a modified output of the content item.

### BACKGROUND

The present disclosure is related to modifying output of a device based on an environment classification of the device.

### SUMMARY

Media content is frequently shared across a wide variety of devices and environments, from personal mobile devices in private homes to large displays in public venues such as conference rooms or waiting areas. For example, a mobile device may cast content that the mobile device is accessing to a television proximate to the mobile device. While this is useful in many circumstances, there may be certain drawbacks. For example, using a private account with a content provider to cast copyrighted content from a mobile device to a television in a public setting, such as a restaurant or bar, may be a violation of copyright law in some jurisdictions. As another example, casting content from a mobile device to a television may serve as a way to circumvent parental control restrictions set on the TV. Indeed, content filtering systems often have a static nature (relying on user input or static rules or other limited functionality) that does not allow for context-sensitive or real-time content modification, such as based on the environment or the characteristics of the viewers, particularly when media is cast between devices or streamed from cloud-based services. This leads to the potential display of inappropriate content (e.g., sensitive or explicit media content) in settings where social norms or comfort levels are not aligned with the media being shown, and/or the display of content in a manner that runs afoul of relevant laws (e.g., display of a football game at a bar by way of a subscription of a household to a content provider).

Video and audio applications often utilize a significant amount of processing resources and computing power. Today devices may present content items (e.g., a movie, TV show, or other streaming content) in seemingly unlimited settings. For example, a smartphone may display a content item in any location the smartphone goes. Similarly, phones and other devices may cast content items on to larger devices for larger audiences. Some of these settings, however, may be public settings and inappropriate for some or all segments of a content item. For example, a content item may include graphic images or language traditionally excluded from public spaces, such as an airport or a multigenerational party. In one approach, a viewer may then manually skip the graphic content. This result causes additional stress on the system as the system uses limited resources, such as network and computing power, to first play undesirable content and then to receive and process additional input from the user. In another approach, a system receives input allowing display of only preapproved content. In some circumstances the system filters preapproved content based on ratings or other metadata. In some circumstances users may block specific programs. However, such approaches are not able to tailor output to a specific environment and cannot adapt to changes in circumstances without manual intervention. Further, they are prone to error as decisions are based only on available data rather than the content itself. These approaches waste computing resources to incorrectly prevent wanted content, mistakenly present unwanted content, and continually receive user adjustments.

Given the drawbacks of the above-described approaches, there remains a need for an alternative presentation system that adjusts content item display according to the environment of the display and without requiring additional user input.

To help overcome these problems, systems, methods, apparatuses, and computer-readable media are disclosed herein for dynamically modifying the output of media content based on the classification of the display's environment and user profiles, e.g., using environmental data, and video and/or audio settings to ensure that content remains appropriate for the situation. In some embodiments, systems, methods, apparatuses, and computer-readable media are disclosed herein for dynamically adjusting the output of media content based on the classification of the viewing environment and the context of the audience, e.g., when casting or streaming from a first device, such as a smartphone or laptop, to a second device, such as a display or media streaming device. In some embodiments, modifying the output of the media content may include modifying the display of the media content and/or audio of the media content. In some embodiments, modifying the output of the media content may include presenting an alternate version of the media content or an alternate portion of the media content, or preventing the display of portion of the media content (or a portion thereof) altogether, or selectively displaying the sensitive content on the user's device (as opposed to the device they're casting to).

The present disclosure relates to adjusting output of a video or audio content item based on the detected surroundings of the presentation to conserve valuable resources and ensure content appropriateness. In some embodiments, the described systems and techniques monitor the surroundings (e.g., by detecting nearby devices) to determine if a display is in a public or private or semi-private setting. The systems and techniques may then adjust the output of the content item to appropriately fit the setting. For example, the systems and techniques may adjust the display of media content to prevent presentation of sensitive content in public settings. In some embodiments, the systems and techniques analyze a scene in a content item to determine what segments are appropriate for the detected setting. In some embodiments, the systems and techniques disclosed herein may be used to determine what segments are appropriate for the detected setting based on available data, such as metadata. For example, each segment may have a rating identified in the manifest. If the identified rating for a segment is determined to be above a given rating, the disclosed systems and techniques may be used to prevent presentation of, or otherwise modify, that segment.

In some embodiments, the disclosed techniques include presenting, via a device, an initial output of a content item, wherein the content item is associated with a content provider. A characteristic of the device is identified, and the systems and techniques determine, based on the identified characteristic, a privacy level of an environment of the device. Based at least in part on the determined privacy level, the systems and techniques may present, via the device, a modified output of the content item.

In some embodiments, the systems and techniques, further, based at least in part on a received input, determine a temporary privacy setting for one or more devices during a time period. During the time period, a first request to play a first content item on the one or more devices is received. Based at least in part on the privacy setting for the one or more devices and a characteristic of the first content item, the systems and techniques prevent the playing of at least a portion of the first content item at the one or more devices or play a modified version of the first content item at the one or more devices. A second request to play a second content item on the one or more devices is also received. Based at least in part on the privacy setting for the device and a characteristic of the second content item, the systems and techniques play the second content item. Such techniques enable an environment, which may otherwise be considered private, to be specified as public, e.g., during a children's birthday party, to control output of content during such event occurring during the time period.

Unlike some approaches, the described systems and techniques alter the presentation of content automatically, based on the environment of the presentation of the content item and without user input. This approach eliminates the need to dedicate processing power and other resources to unwanted content and additional user input. The disclosed techniques allow for nearly instantaneous adjustments that may account for privacy changes during presentation. Moreover, the disclosed techniques may help avoid circumvention of parental controls and/or copyright laws by way of a casting device workaround. The determination of desirability of a scene based on a detected audience or privacy level further reduces wasted resources as it is less prone to mistakes than systems that rely on broad categorization and user decisions.

The systems and techniques disclosed herein may use different approaches for altering a content item output. In some embodiments, altering the output of the content item includes removing or replacing scenes deemed inappropriate for the detected audience. Such altering of the output of the content item may be performed at, for example, the casting device, the “cast to” device, or any other suitable device. For example, the casting client can make the alteration based on the detected environment of the display. In some embodiments, separate public and private (and semi-private) versions of the content item are available, and the systems and techniques display the appropriate version according to the determined audience. In some embodiments, the systems and techniques analyze segments or scenes of the content item during presentation to determine whether that segment or scene is appropriate for the audience. In some embodiments, the systems and techniques determine whether a segment or scene of media content is appropriate for the audience based on available data, such as metadata associated with the media content. The customized presentation avoids sweeping generalizations that may limit presentation and efficiency in alternative approaches.

In some embodiments, a second device casts or streams the initial output of the content item to the first display device. The second device may be in communication with the content provider to receive the modified output of the content item and provide the modified output of the content item to the first device. In some embodiments, an indication of the determined privacy level is provided for display on the second device, prior to casting or streaming the initial output of the content item to the first displaying device.

In some embodiments, an option to stream or cast the content to the first displaying device is provided for display on the second casting device based on digital rights associated with the content item.

In some embodiments, a manifest file associated with the content item is provided by a server to the second device, and wherein presenting, via the first device, the modified output of the content item is further based at least in part on the server altering at least a portion of the manifest file based at least in part on the privacy level of the environment and providing the altered manifest file to the first device.

In some embodiments, the systems and techniques analyze at least one segment of the content item (e.g., an initial or original version of the content item), and present the modified output of the content item based on the analyzing.

In some embodiments, determining the privacy level includes determining whether the environment of the device is a public environment or a private environment, and presenting the modified output of the content item is based at least in part on determining that the device is in a public environment.

In some embodiments, wherein a manifest file is provided for segments of the content item when the environment of the device is a private environment, and based at least in part on determining that the device is in a public environment, the manifest file is updated to enable the modifying of the output of the content item, e.g., when the environment privacy level changes during streaming. In some embodiments, the manifest file may include suitable playlists, and adaptation sets for multiple different types of environments of different privacy levels.

In some embodiments, the characteristic of the device on which a privacy level is determined is a number of devices in the device's environment determined to have been previously paired with the device, and wherein determining that the device is in a public environment is based at least in part on determining that the number of devices exceeds a threshold. In some embodiments, the number of devices having been previously paired may be one factor, e.g., a type of environment may be taken into consideration. For example, a number of devices having previously paired to a vehicle may exceed a threshold, but such vehicle may nonetheless be considered a private environment, e.g., based on being a vehicle. In some circumstances, a vehicle may be considered a public environment, e.g., in a ride-sharing vehicle or a public bus.

In some embodiments, the display device is connected to a Wi-Fi network, and wherein the characteristic used to determine a privacy level is based on a Wi-Fi network type of the Wi-Fi network, and wherein determining that the device is in a public environment is based at least in part on the Wi-Fi network type being indicative of a public network.

In some embodiments, determining that the device is in a public environment is based at least in part on determining that an ambient noise level in the environment of the device exceeds a threshold.

In some embodiments, determining that the device is in a public environment is based at least in part on determining that a number of inputs received at the device over a period of time via a remote control is fewer than a threshold and/or based at least in part on determining that a number of device in close proximity (e.g., within a threshold distance) of the first device (or the second device) exceeds a threshold.

In some embodiments, when the systems and techniques present the initial output of the content item, a modified version of a future segment of the content item is downloaded while the device is connected to a Wi-Fi network, the determining the privacy level of the environment of the device occurs while the device is not connected to the Wi-Fi network, and the device is configured to output the modified output of the content item using the modified version of the future segment.

In some embodiments, one or more display devices are included in a plurality of devices located in a home network, and a temporary privacy setting is applicable to each of the plurality of devices connected to the home network during a time period.

In some embodiments, one or more display devices are located in a location, and a temporary privacy setting is applicable to each of a plurality of devices present in the location during the time period.

In some embodiments, there is a request to play audio at a first display device via a Bluetooth® connection with a second device, and the systems and techniques prevent the audio from being played at the first device via the Bluetooth connection with the second device based on comparing a parental control rating of the audio to a parental control rating associated with a temporary privacy setting.

In some embodiments, a request is received from a casting device based on the casting device attempting to cast or stream a content item to a first display device, and the systems and techniques prevent the at least a portion of the content item from being played at the first display device via the casting or streaming based on comparing a parental control rating of the content item to a parental control rating associated with a temporary privacy setting.

In some embodiments, a time period associated with a temporary privacy setting corresponds to a particular event being held at a location associated with the one or more devices.

In some embodiments, based on receiving a first request from a requesting device and comparing a parental control rating of a content item to a parental control rating associated with a temporary privacy setting, the systems and techniques provide a notification to a requesting device indicating that the parental control rating of the content item exceeds the parental control rating associated with the temporary privacy setting, and recommend one or more content items compatible with the parental control rating associated with the temporary privacy setting.

In some embodiments, prior to a time period, the systems and techniques receive a request to store a content item, and, during that time period, receive a request to access the stored content item. The systems and techniques may then play a modified version of a content item by retrieving a first subset of a plurality of portions of the stored content that complies with a parental control rating associated with a temporary privacy setting and preventing retrieval of a second subset of the plurality of portions of the first content item that do not comply with the parental control rating associated with the temporary privacy setting.

In some embodiments, a temporary privacy setting comprises a setting to treat one or more devices as being in a public environment or as being in a private environment.

In some embodiments, a received input indicates a type of event is to occur during a time period, and a temporary privacy setting is set during the time period based on the type of event indicated in the received input. In some embodiments, if the display device (e.g., the “cast to” device), or one or more applications thereof, has a content rating (e.g., a parental control setting) already associated with it, a version (e.g., an appropriate adaptation set in the manifest file) matching the content rating may be selected for playout.

### BRIEF DESCRIPTION OF THE DRAWINGS

FIGS. 1A-1B show illustrative systems for controlling output of media content in an environment, in accordance with some embodiments of the present disclosure;

FIG. 2 shows a workflow for an illustrative process for controlling output of media content in an environment, in accordance with some embodiments of this disclosure;

FIG. 3 shows an example display on a second device, in accordance with some embodiments of the present disclosure;

FIG. 4 shows an example casting selection display on a first device, in accordance with some embodiments of the present disclosure;

FIG. 5 shows an example workflow for modifying a manifest file, in accordance with some embodiments of the present disclosure;

FIG. 6 shows an example workflow for modifying a manifest file, in accordance with some embodiments of the present disclosure;

FIG. 7 shows an example workflow of selecting alternate content, in accordance with some embodiments of the present disclosure;

FIG. 8 shows an example workflow, in accordance with some embodiments of the present disclosure;

FIG. 9 shows an illustrative system for controlling output of media content in an environment during an event, in accordance with some embodiments of the present disclosure;

FIG. 10 shows a workflow of the output control system integrating a smart home system, in accordance with some embodiments of the present disclosure;

FIG. 11 shows an example workflow of the output control system during a scheduled event, in accordance with some embodiments of this disclosure;

FIGS. 12-13 show illustrative devices, systems, servers, and related hardware for selecting a node to be assigned a processing task, in accordance with some embodiments of this disclosure;

FIG. 14 is an illustrative flowchart of a process for determining an environment of a display and displaying a media asset based on the determined environment, in accordance with some embodiments of this disclosure; and

FIG. 15 is an illustrative flowchart of a process for preventing display of a media asset based on a determined environment, in accordance with some embodiments of this disclosure.

### DETAILED DESCRIPTION

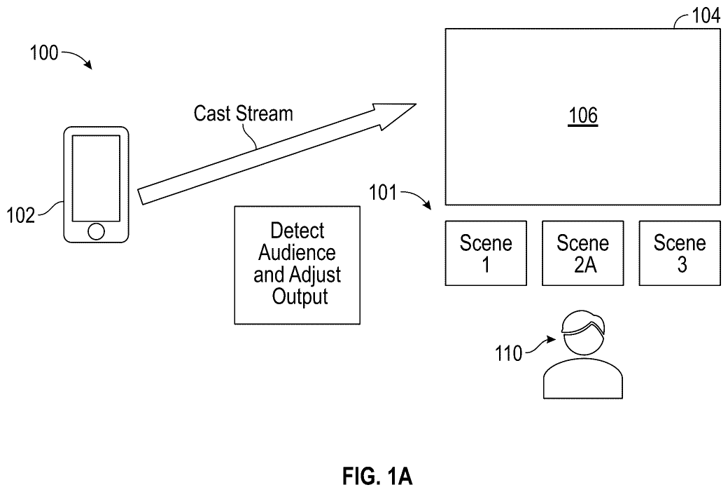

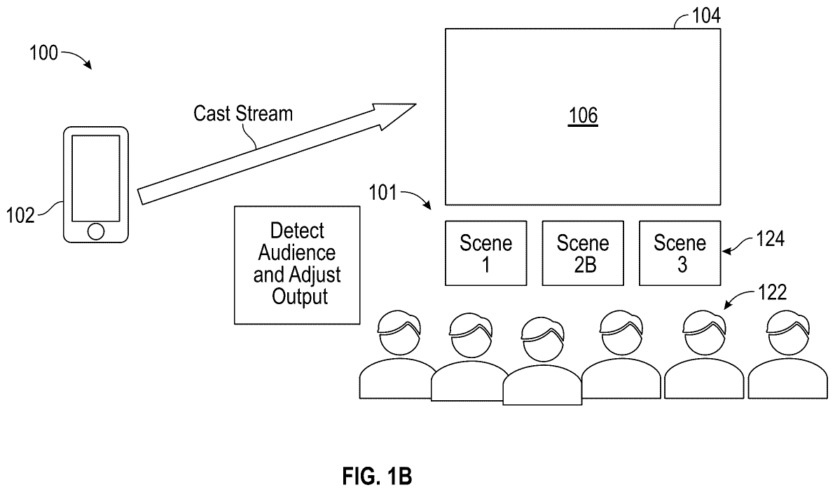

FIGS. 1A-1B show illustrative systems for controlling output of media content in an environment 101, in accordance with some embodiments of this disclosure. The technique shown in FIGS. 1-15 may be implemented at least in part by output control system 100. In some embodiments, the architecture of output control system 100 is built around integrating a combination of a user, client, or casting device, a display device, a computing server, and/or a streaming platform. Output control system 100, in the example shown in FIGS. 1A-1B, may comprise first device 102 (e.g., a smartphone, a tablet, a mobile device, an extended reality (XR) device, or any other suitable device, or any suitable combination thereof) and second device 104 (e.g., a television, a projector, a monitor, a computer, an output speaker, or any other suitable device, or any suitable combination thereof) and/or other components. Environment 101 may be, for example, a residential environment, an enterprise or corporate environment, an educational environment, an entertainment venue or hospitality environment (e.g., a restaurant, bar, casino), a transportation provider (e.g., an airline, airplane, train, common carrier), a healthcare or hospital environment, hotel, and/or any other suitable environment.

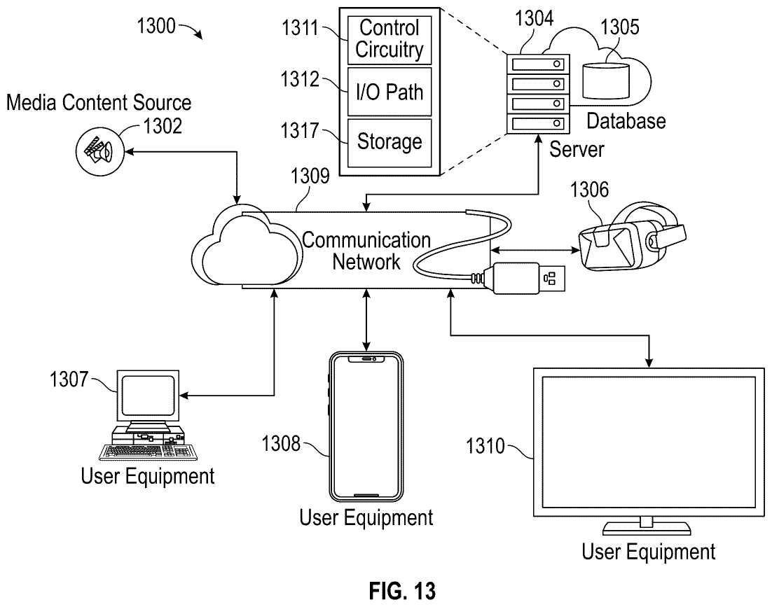

Output control system 100 may be executed at least in part at one or more devices (e.g., first device 102 and second device 104) and/or at one or more remote servers (e.g., media content source 1302 and/or server 1304 of FIG. 13) and/or at any other suitable computing device(s). Output control system 100 may be configured to perform the functionalities (or one or more portions thereof) described herein. In some embodiments, output control system 100 may comprise or be incorporated as part of any suitable application or software. For example, output control system 100 may comprise or be implemented in conjunction with one or more video or audio streaming applications, smart home ecosystems to enhance content control across interconnected devices; video or audio presentation applications, XR applications; content delivery network (CDN) applications; network management applications; video game applications including cloud gaming applications, one or more image, video and/or textual acquisition, recognition and/or processing applications; one or more content creation applications; one or more machine learning models or artificial intelligence models; or any other suitable application(s) or any combination thereof. Output control system 100 may comprise or employ any suitable number of displays; sensors or devices such as those described in FIGS. 1-15; or any other suitable software and/or hardware components; or any combination thereof.

As shown in FIG. 1A, first device 102 transmits a request (e.g., based on user input) over a network (e.g., communication network 1309 of FIG. 13) such as, for example, a Wi-Fi network, or via another communication protocol (e.g., a Bluetooth connection), to cast a media asset 106 to second device 104. Media asset 106 may be provided may be provided via any suitable content provider, e.g., a streaming media service, a live content service, an Internet service provider (ISP), a cloud service provider, and/or any other suitable content source, or any suitable combination thereof. In some embodiments, media asset 106 may be stored locally at device 102. First device 102 and second device 104 may be any devices capable of communicating via a wireless and/or wired (e.g., HDMI) connection, and displaying visual (e.g., image and/or video) content and/or outputting audio media content including, for example, a television, computer, smartphone, XR headset, or any other suitable device, or any suitable combination thereof. In some embodiments, first device 102 and second device 104 are the same device and the casting is merely a request to display a selected content item. For example, the device 102 may be a smart speaker capable of receiving commands and outputting audio.

As referred to herein, the terms “content item,” “media asset,” “media content,” or “content” may be understood to mean electronically consumable user assets, such as 2D content, television programming, as well as pay-per-view programs, on-demand programs (as in video-on-demand (VOD) systems), live content, Internet content (e.g., streaming content, downloadable content, webcasts, etc.), video clips, audio, content information, pictures, GIFs, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, transmitted to, processed, displayed and/or accessed by a computing device, and/or can be part of a live performance or live event. In some embodiments, the media asset may be generated for display from a broadcast or stream received at a computing device, or from a recording stored in a memory of the computing device and/or a remote server.

In the example of FIG. 1A, media asset 106 includes sequential segments scene 1, scene 2A, and scene 3, which together form a consecutive time block within media asset 106. For example, scenes 1, 2A, and 3 may each be groups of frames of a video content item, e.g., scene 1 may comprise frames showing and/or describing background information about an event, scene 2A may comprise frames showing and/or describing the event itself, and scene 2 may comprise frames showing and/or describing the aftermath of an event.

As shown in FIG. 1A, output control system 100 includes a first device 102 capable of initiating media streaming, and a second device 104 with a display and/or other output capabilities. Output control system 100 may employ one or more techniques to classify its environment as public, private, or semi-private-private. Output control system 100 may determine characteristics of (e.g., indicative of a privacy level of) an environment 101 of second device 104. In some embodiments, the classification of environment 101 as public, private, or semi-private may be performed prior to receiving the request from client device 102 to cast media asset 106 to second device 104, or, in response to (or based at least in part on) receiving the request from client device 102, to cast media asset 106 to second device 104. In some embodiments, the classification of environment 101 as public, private, or semi-private may be performed after an initial portion or an initial output of media asset 106 has begun being cast to and output at second device 104 (e.g., while scene A is being presented) or prior to permitting media asset 106 to be cast to second device 104. In some embodiments, a type of profile that a user has with a content provider providing the media asset may be used, at least in part, to classify the environment, e.g., if a user of the casting device has a profile that allows for display of the media asset at a public venue, this may weigh in favor of permitting the casting of the media asset at such venue, or if a user of the casting device has a profile that indicates the profile is for a household, this may weigh in favor of preventing the casting of the media asset in its original form at the public venue.

The classification of environment 101 as public, private, or semi-private may be based on any suitable data, e.g., location data indicating a type of the environment (e.g., a school, a bar, an airport, a dorm room at a college, or any other suitable type of environment), and/or one or more contextual inputs (e.g., determined by a display device or media streaming device, which may correspond to second device 104), including data derived from Wi-Fi network characteristics, motion detection, ambient audio or video analysis, remote control interaction/input frequency, and detection of the presence of proximate Bluetooth device(s). These inputs work together to classify the environment in real time, enabling the system to adjust the media content being cast or streamed to ensure that inappropriate material is not displayed in public or semi-private settings, while allowing more flexibility in private environments.

In some embodiments, the data used for the classification may include external data received using one or more sensors included in or connected with second device 104 or output control system 100. The data may include a wide variety of information indicative of characteristics of the environment of second device 104. For example, the data may include information regarding an audience or surroundings of second device 104, e.g., based on images of environment 101 captured by a camera (and/or any other suitable sensor), logs of available Wi-Fi networks at environment 101 (and characteristics thereof), a list of available Bluetooth devices in environment 101 or having been detected in environment 101 during prior times, ambient sounds detected in environment 101 or having been detected in environment 101 during prior times, or any other suitable data, or any suitable combination thereof.

The privacy level determined by output control system 100 may be, for example, public, private, or semi-private. For example, a classification of environment 101 as public may be based one on or more of identifying many detected users or onlookers (e.g., above a threshold in a vicinity of device 104), a certain type of environment 101 (e.g., an airport, hotel lobby, or bar), many devices detected (e.g., above a threshold), detecting a public Wi-Fi network (e.g., having no password or limited security protocols), and/or based on any other suitable information. A classification of an environment as private may be based at least in part on, for example, identifying few detected users or onlookers (e.g., fewer than a threshold in a vicinity of device 104), a certain type of environment 101 (e.g., a home environment), few devices detected (e.g., fewer than a threshold), detecting a private Wi-Fi network (e.g., having reasonably strong security protocols), and/or based on any other suitable information. A classification of an environment as semi-private may be based at least in part on, for example, identifying a certain number of users (e.g., greater than the threshold for private environment, but less than the threshold for public environments), a certain type of environment 101 (e.g., a conference room in an office), identifying a certain number of devices (e.g., greater than the threshold for private environment, but less than the threshold for public environments), detecting a private Wi-Fi network (e.g., having strong security protocols falling short of those of a private environment, but stronger than security protocols for a public environment), and/or based on any other suitable information.

Based on the classification of environment 101 (e.g., based on the one or more inputs and/or contextual data, which may be considered in combination to perform the classification), where such classification, in some instances, may be performed in real time, output control system 100 may dynamically adjust one or more portions of media asset 106 to ensure that the presentation of media asset 106 remains appropriate for the determined type of environment. For example, output control system 100 may restrict inappropriate content in public or semi-private environments, while allowing more flexibility in private environments.

Based on the privacy designation, the output control system 100 selects appropriate portions of media asset 106 for output. For example, in a public environment, scenes including violence or other graphic content may be offensive or shocking to onlookers, and thus output control system 100 may avoid presenting those scenes and/or substitute other content (e.g., an alternative scene, a blank screen, slate content, a scenic image or video, or any other suitable replacement content or alternative scenes) for such scenes. Determining which (if any) portions of media asset 106 should be modified may be based on data about the media asset 106, including for example, metadata, image analysis, audio analysis, and/or any other suitable method, to identify characteristics of portions of a media asset. In some embodiments, output control system 100 may display an idle screen in place of the offensive scenes. In some embodiments, the output control system 100 may blur or mute offensive aspects of the scene. In some embodiments, the output control system skips the offensive scenes, and/or provides an indication of why the scenes are being blocked, obscured, replaced, or skipped. In another example, if output control system 100 determines that the environment of second device 104 is private, output control system 100 may display the media asset 106 in its original form, despite any offensive or graphic content.

In some embodiments, output control system 100 provides local content adjustment capabilities that allow for offline media playback modification. For example, by downloading alternate content and metadata alongside the primary content of media asset 106, output control system 100 may continue to adjust media based on the environment, even without a cloud connection, ensuring continuous and contextually appropriate media delivery regardless of network availability.

In the example seen in FIG. 1A, output control system 100 determines that the audience of second device 104 includes a sole individual 110 (or fewer than a threshold number of individuals). The output control system 100 determines, based on one or more portions of the contextual data, sensor data discussed above and/or any other suitable data, that second device 104 is in a private setting. Because second device 104 is in a private setting, there is likely no need to alter the media asset 106 to the taste of a diverse audience, as well as potentially less concern that a cast of media asset 106 to second device 104 will run afoul of, e.g., copyright laws in the relevant jurisdiction. Based on environment 101 being classified as private, output control system 100 may cause presentation of scenes 1, 2A and 2, here, the original form of media asset 106.

On the other hand, in the example seen in FIG. 1B, output control system 100 determines a classification for environment 101 as public, either initially after receiving the request to cast media asset 106 from first device 102 to second device 104, or at a later time than a time associated with FIG. 1A (e.g., if a larger audience 122 is determined to now be present, after audience 110 was initially present). For example, output control system 100 may determine that audience 122 includes a number of users (e.g., five) exceeding a threshold (e.g., three) associated with public environments. Output control system 100 may determine that, because at least a portion (e.g., scene 2A) of media asset 106 includes objectionable content, its original form may be inappropriate for public environments. As another example, output control system 100 may determine that no portions of media asset 106 are appropriate for public settings, given a particular type of profile a user of first device 102 has with a content provider (e.g., a profile for a residence, while environment 101 is a restaurant, where presenting media asset 106, such as a live professional sports game, in a public setting like a restaurant would be problematic for legal or contractual reasons).

In the example of FIG. 1B, based on the classification of environment 101 as a public environment, output control system 100 presents an alternate form of media asset 106 and displays presentation 124, which includes scenes 1, 2B, and 3, e.g., output control system 100 replaces scene 2A with scene 2B in the public presentation of media asset 106. In some embodiments, if, during such public presentation of media asset 106 in FIG. 1B, output control system 100 determines that the classification of environment 101 has changed (e.g., based on members of audience 122 exiting environment 101, and/or based on any other suitable factors), output control system 100 may revert to performing the processing shown in FIG. 1A (e.g., for private environments). For example, if, at a later time, the audience of second device 104 reverts to audience 110 (or otherwise is reduced to a number of users fewer than a threshold), and/or fewer devices are detected in environment 101, and/or based on any other suitable factors, output control system 100 determines second device 104 is again in a private setting, and output control system 100 may revert to presenting media asset 106 in its original form. In some embodiments, the modified scene may be the first scene that appears after casting is initiated.

In some embodiments, output control system 100 utilizes motion detection to further refine the environment classification. Motion sensors, such as, for example, infrared detectors or cameras, may monitor the presence and movement of individuals in proximity to second device 104. In environments where minimal motion is detected, such as, for example, a quiet home setting, output control system 100 may classify the environment as private. However, if the output control system 100 detects multiple individuals moving within the area, such as in a conference room or shared public space, the system may classify the environment as semi-private or public. The output control system 100 can dynamically adjust this classification in real time, responding to changes in the number of people or the type of movement detected. Furthermore, the output control system 100 may further use radio frequency (RF) sensing, performed using any suitable network such as, for example, Wi-Fi or Bluetooth, for motion and occupancy detection. In some embodiments, such techniques rely on using wireless signals to detect occupancy and motion in their environment rather than a separate sensor, e.g., infrared (IR) and/or camera.

In some embodiments, second device 104 or a remote control associated with second device 104 collects or monitors ambient audio to provide additional data for classifying the environment. By continuously monitoring the noise level in the surrounding area, the output control system 100 can infer the nature of the environment. For example, a low-noise environment is typically indicative of a private setting, such as, for example, a home or personal office, whereas environments with higher background noise, such as, for example, those with frequent conversations or mechanical noise, suggest that the display is located in a public or semi-private space. The output control system 100 processes this audio data in real time or near real time, adjusting the classification as the noise level fluctuates, ensuring that content remains appropriate for the audience at any given time. The output control system 100 may also factor in the frequency and type of remote control input received by the second device. For example, in private environments, users tend to interact frequently with the display through a remote control to adjust settings, change media, or navigate menus. Output control system 100 monitors these inputs, and output control system 100 may, if it detects frequent interaction, classify the environment as private. In contrast, public displays typically receive minimal or no remote control input, as these displays often operate in a passive mode or are controlled centrally. If output control system 100 detects little to no remote control interaction over an extended period of time, it may classify the environment as public or semi-private. Output control system 100 can also differentiate between personal remote controls paired directly with the display or second device and shared control systems commonly used in public environments, further refining the classification process.

In some embodiments, second device 104 receives data or continuously scans for nearby Bluetooth (or other suitable short-range connection protocol, Wi-Fi, or other suitable network) devices and assesses their type and proximity. In private environments, such as a home or personal office, known personal Bluetooth devices such as smartphones, wireless earbuds, or smartwatches are often present and actively connected to the second device or to other devices within close proximity. The presence of these personal Bluetooth devices, particularly if they are paired with the second device, can lead output control system 100 to classify the environment as private. For instance, if a user's personal smartphone and wireless headphones are detected, the system may infer that the device is being used in a private or semi-private environment, such as a home or personal workspace. Conversely, in public or semi-private environments, the system may detect multiple unfamiliar or unpaired Bluetooth devices, such as those belonging to visitors or passersby. A large number of unrecognized Bluetooth devices in close proximity to the second device may suggest that the environment is public or semi-private, leading the system to apply more stringent content restrictions. For example, in a busy office or public space, output control system 100 might detect Bluetooth devices from multiple users, reinforcing a classification of the environment as public and prompting the system to restrict the display of sensitive or inappropriate content.

In some embodiments, Output control system 100 may process all of these inputs—Wi-Fi network characteristics, motion detection, ambient audio analysis, remote control input and proximate Bluetooth devices—together to determine the most appropriate classification of the environment. Output control system 100 transmits the classification to the first device, such as a smartphone or laptop, which initiates the media streaming or casting session. The first device, or other component of the output control system 100, such as a remote server, adjusts the content accordingly, ensuring that inappropriate material is not displayed in public or semi-private settings while providing greater flexibility in private environments. The output control system 100's ability to dynamically adjust the classification in real time or near real time based on changing conditions ensures that media content is always suitable for the viewing environment, providing a seamless and adaptable media experience.

In some embodiments, the environment classification may also be explicitly set by an admin (or other user) of one or more portions of the output control system 100 via a settings preference interface. These various inputs work together to ensure that the classification of the viewing environment is accurate, allowing for the dynamic adjustment of media content based on the context in which the display is used. The output control system 100 may classify privacy via Wi-Fi by analyzing the Wi-Fi network to which the second device is connected. If the second device 104 is connected to a Wi-Fi network that is recognized as private, such as, for example, a known home Wi-Fi network with a specific service set identifier (SSID) (e.g., MyHomeWiFi), output control system 100 recognizes this SSID as being associated with a private environment, and automatically classifies the environment as private (or otherwise uses such information as a data point weighing in favor of a classification of the environment as private). Conversely, if the second device connects to a public or guest Wi-Fi network typically found in offices (e.g., with the SSID “OfficeGuest.”), conference rooms, or public spaces, the environment may be classified as public or semi-private (or otherwise uses such information as a data point weighing in favor of a classification of the environment as public or semi-private). Output control system 100 may also analyze the security protocols of the Wi-Fi network, such as whether the network uses strong encryption (e.g., WPA2 or WPA3) or is open and unencrypted, to further refine the classification. Additionally, the output control system 100 may monitor the number of devices connected to the network, with a higher number of connected devices typically indicating a public or semi-private environment.

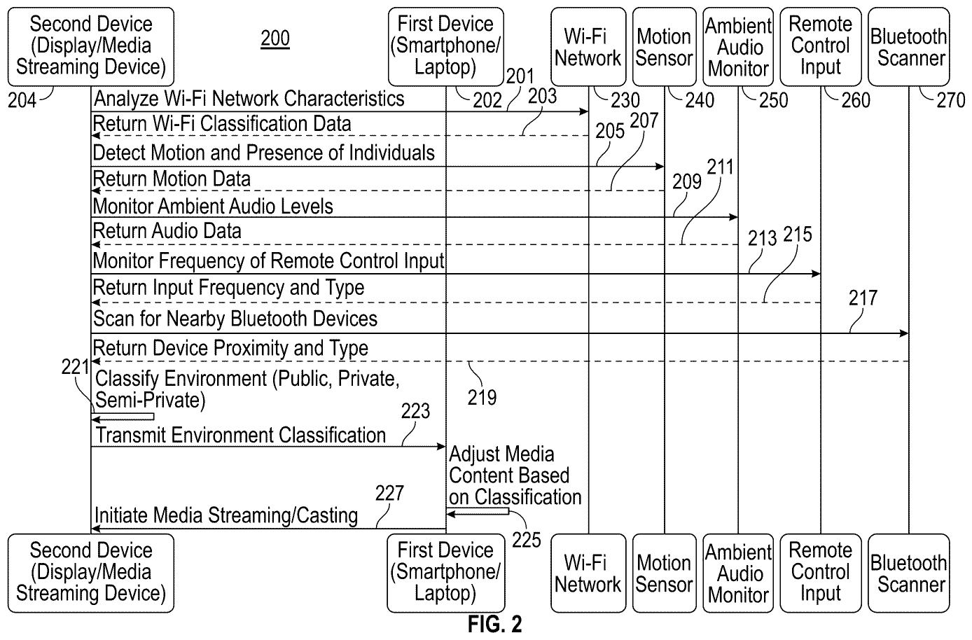

FIG. 2 shows a workflow for an illustrative process 200 for controlling output of media content in an environment, in accordance with some embodiments of this disclosure. At 201, second device 204 (e.g., second device 104 of FIGS. 1A-1B) may analyze Wi-Fi network characteristics of Wi-Fi network 230. At 203, Wi-Fi network 230 (e.g., by way of a router or modem or other networking equipment providing Wi-Fi network 230 or other local area network (LAN)) returns to second device 204 Wi-Fi classification data (e.g., a Wi-Fi connection type, such as a home connection or public connection). The Wi-Fi data may include indicators that allow the output control system to determine whether or not it recognizes the Wi-Fi connection as a home or otherwise safe and private connection.

At 205, second device 204 monitors, requests or detects sensor data received from motion sensor 240, indicating presence of individuals such as viewers or onlookers in a vicinity of (e.g., within a threshold distance of, and/or determined to be gazing at) second device 104. In response, at 207, motion sensor 240 returns such motion data to the second device 204. The motion sensor 240 may report high levels of motion or low levels of motion. In some embodiments, the motion sensor 240 may determine that the type of motion is indicative of people, a party, a private setting, or a public setting. In some embodiments, motion sensor 240 may include or be in communication with image analysis software and may report whether or not images of the environment include people, or groups of people, in motion, and/or whether the images include any other suitable objects.

At 209, second device 204 monitors, requests or detects ambient audio levels by querying ambient audio monitor 250. At 211, the ambient audio monitor 250, based at least in part on the query, transmits audio data to the second device 204. The ambient audio monitor 250 may report levels of ambient noise, that is, high, low, or medium, for example. In some embodiments, the ambient audio monitor 250 may classify types of ambient noise such as conversation, music, or that associated with common surroundings. For example, the ambient audio monitor 250 may report, based on ambient noise, that the second device 204 is in, for example, a coffee shop, airport, or restaurant.

At 213, the second device 204 monitors frequency of remote control inputs and queries the remote control input 260. In response, at 208, the remote control input 260 sends the second device 204 input and type data. Input and type data may include, for example, how often a user interacts with second device 204 or what type of input it receives, such as, for example, volume control, whether or not input requests other applications, and time of day of typical input interactions.

At 217, the second device 204 scans for nearby Bluetooth devices (or any other suitable network or connection capability of devices) by querying the Bluetooth scanner 270. In response, at 219, the Bluetooth scanner 270 returns Bluetooth device proximity and type. For example, the Bluetooth scanner 270 may determine the type of Bluetooth devices nearby, such as the number of smartphones, headphones, and personal computers. The Bluetooth scanner may also indicate whether or not detected devices are familiar or trusted.

At 221, using the collected data described above, the second device 204 classifies the privacy level of the environment at 211. The privacy level may be, for example, private, public, or semi-private and may be based on any of the described data collected at 201-310, or other additional data available. For example, the second device 204 may determine that the environment is public due to a high level of ambient noise recognized as conversation. In another circumstance, it might classify the environment as semi-private based on the detection of multiple unfamiliar Bluetooth-connected smartphones. In another scenario, the second device 204 may determine that the environment is private based on little detected motion (e.g., below a threshold at an instant in time or over a period of time).

At 223, second device 204 transmits the environment classification of 219 to first device 202 (e.g., first device 102 of FIGS. 1A-1B), using any suitable communication technique. At 225, first device 204 adjusts media content (e.g., as in FIG. 1A, replaces scene 2A with scene 2B in media asset 106) based on the classification, and, at 227, initiates media streaming or casting at the second device 204.

In some embodiments, output control system 100 has access to profiles such as, for example, demographic profiles of known users in the environment. This may be useful to enforce content moderation even in, e.g., semi-private environments, in which if some viewers are determined to be in the vicinity, then some content may not be shown based on, for example, the ages of the viewers. Such profiles may be developed by a content platform and integrated into a streaming system or cascaded to the casting device (e.g., first device 102 of FIG. 1A). The first device or other component of output control system 100 may make such information available to the second device (e.g., second device 104 of FIG. 1A) when a query is received from the second device or output control system 100 with parameters identifying detected devices. The first device may revert back with whether any of the detected devices are known devices and other owner profile information if they are personal devices. Other platforms, such as, for example, a smart home system may also provide such information if the output control system 100 queries. In some embodiments, one or more of the steps described in relation to FIG. 2 may (additionally or alternatively) be performed at device 202. For example, as devices 202 and 204 may be in proximity to each other, certain tasks indicated as being assigned or performed by device 204 in FIG. 2 may instead by performed by device 202, e.g., Bluetooth scanner 270 or ambient audio monitor 250, and/or any other suitable tasks.

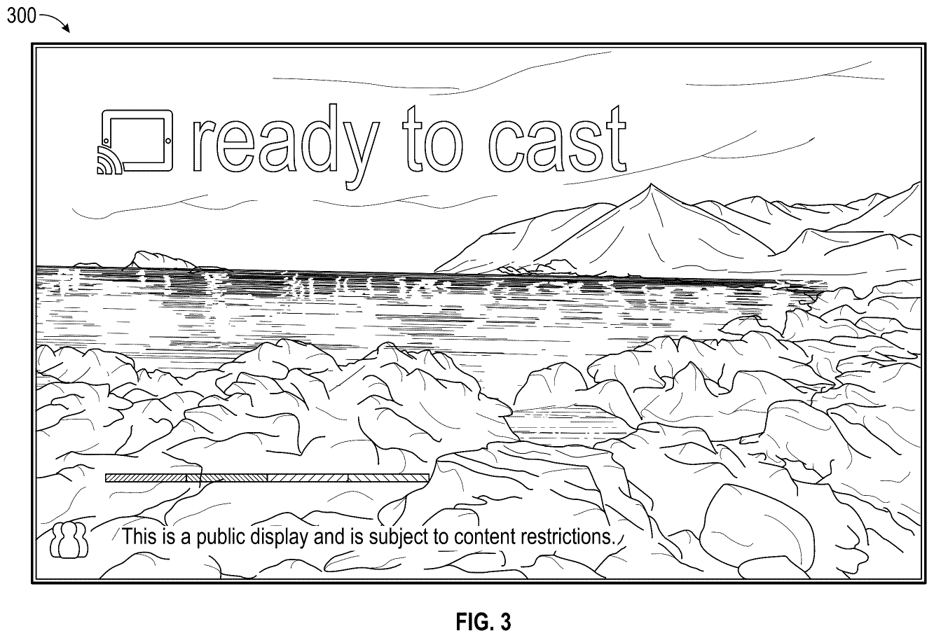

FIG. 3 shows an example display 300 on a second device, in accordance with some embodiments of the present disclosure. For example, displayed interface 300 may be shown (e.g., at second device 104 of FIGS. 1A-1B) to a user when a user first attempts to cast from their device to a public display. Displayed interface 300 includes an indication to indicate that a first device (e.g., first device 102 of FIGS. 1A-1B), may begin casting, and an indication that the second device is a public device and is subject to content restrictions, e.g., copyright, digital rights, parental restrictions, or otherwise.

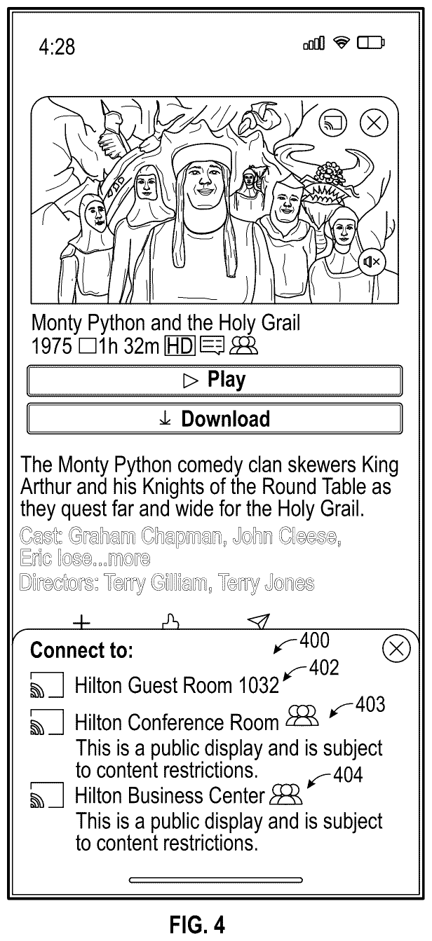

FIG. 4 shows an example casting selection display 400 on a first device, in accordance with some embodiments of the present disclosure. Display 401 may be provided on a first device, such as first device 102, with options for casting content to three different output devices. The options include option 402 (e.g., Hilton Guest Room 1032, with a private classification), option 403 (e.g., Hilton Conference Room, a public setting), and option 404 (e.g., Hilton Business Center, a public setting). Options 403 and 404 may be associated with an indication that such options include casting content to a public device that is subject to content restrictions, e.g., copyright, digital rights, parental restrictions, or otherwise. In some embodiments, a semi-private option may be provided, where a device may display content intended for one viewer but exposed to onlookers. Upon receiving a selection of a device, the first device may transmit a casting request to cast or stream content (e.g., the movie Monty Python and the Holy Grail shown in FIG. 4) to the appropriate device (e.g., second device 104 of FIG. 1A).

In some embodiments, a second device (e.g., second device 104 of FIG. 1A-1B), of output control system 100 fetches media content from a cloud-based service, such as a streaming service, while simultaneously sending classification information about the viewing environment—whether it is public, private, or semi-private—to the cloud service. Such cloud-based service, in some embodiments, is included in output control system 100. Upon receiving this classification, the cloud service processes it in real time or near real time and modifies the media stream accordingly, ensuring that the content delivered is suitable for the environment. The output control system 100 may modify the media stream through one or more of multiple mechanisms, one of which may involve manipulating a streaming manifest file of the media content (e.g., media asset 106 of FIGS. 1A-1B). The cloud service, upon receiving the environment classification, can alter or modify the manifest file dynamically to skip, replace, or modify specific segments of the stream. In some embodiments, the altered or modified manifest may be provided to the client device (e.g., the casting device and/or the “cast to” device). In some embodiments, providing the altered or modified manifest file may include, rather than sending a whole new manifest file, sending to the client device a patch update based at least in part on a change in the privacy level of the environment. Such patch update may be transmitted to the client device from a server, without the client device having to fetch the entire file again. For example, the alteration of the manifest file may, in some embodiments, take the form of providing a link to an alternative manifest file within the original manifest file (e.g., in order to swap out or replace ads), a link to alternative content, etc. The video player may then utilize the alternative manifest file to retrieve different advertisements (ads) that are suitable for its environment. In one example, if the classification indicates that the environment is public, the cloud service might alter the manifest file to exclude segments including explicit content and instead point to alternate segments with family-friendly content or placeholders. This may help allow the content to be seamlessly modified during presentation without interrupting the streaming session. In some embodiments, to send an updated to remove or ignore a segment of a manifest, the server can send an update to instruct the client to skip a segment. For example, the server may send a patch update that has a <RemoveSegment> element (or any other suitable element instructing removal or ignoring of a segment) that specifies the segment's timestamp (t) and duration (d) to remove from the timeline, and the client's player utilizes the patch to skip the segment. As another example, a segment unavailable may be made unavailable by manipulating its @availabilityStartTime, @availabilityEndTime, or setting it to a time outside the playback window. In some embodiments, the manifest file may also include different adaptation sets within a period, in which each set also includes a rating. The selection of the adaptation set may be based on the set rating and the determined environment of the display device.

In some embodiments, a media asset, such as media asset 106 of FIGS. 1A-1B, includes a series of media segments. In some embodiments, each media segment may also be associated with a content rating or metadata that specifies the nature of the content within that segment, such as its suitability for different audience types or environments. These content ratings can be aligned with established rating systems (e.g., PG, PG-13, R) or use custom classifications based on the specific content provider's guidelines. By attaching content ratings to each segment, the cloud service or first device (e.g., first device 102 of FIGS. 1A-1B) can make more granular decisions about which portions of the media are suitable for display in a given environment. The content rating of each segment can be used by the cloud service to automatically adjust the stream according to the environment classification. For example, if a segment is tagged with an “R” rating for explicit content and the environment is classified as public, the cloud service can modify the manifest file to skip that segment entirely, replacing it with either a more suitable version (such as a PG-rated alternate scene) or a placeholder message. The cloud service may also choose to mute audio or apply visual filters to sensitive segments without completely omitting them.

In some embodiments, the first device may receive updated manifest file data from the cloud service, ensuring that any adjustments are seamless during the playback process. In addition to cloud-based content adjustment, the first or second device may be equipped with the ability to make content modifications locally. Since the content rating metadata is embedded in each segment, the devices or output control system 100 can act on this data to enforce content restrictions even without real-time input from the cloud. For example, if the environment classification changes mid-stream from private to semi-private, the first device can automatically refer to the content rating of the currently playing segment and take appropriate action, such as skipping explicit segments, muting audio, or displaying a placeholder image. This local capability ensures that content adjustments be made quickly and efficiently, even in cases where network conditions might limit the cloud service's ability to make timely modifications.

The following is an example of a DASH MPD manifest file with content ratings and alternate adaptation sets. The manifest file includes an R-rated adaptation set, a family-friendly PG-rated adaptation set, and a placeholder adaptation set for skipping sensitive content. The SupplementalProperty element defines content ratings, and the output control system 100 can dynamically switch between adaptation sets based on the environment classification (e.g., public or private) during media playback.

```
  <MPD xmlns=“urn:mpeg: dash: schema:mpd:2011” minBufferTime=“PT1.5S”
type=“static”
  mediaPresentationDuration=“PT2H30M0S” max SegmentDuration=“PT2S”
  profiles=“urn:mpeg:dash:profile:isoff-on-demand:2011”>
  <Period id=“1” duration=“PT2H30M0S”>
  <!-- Original Video Adaptation Set (R-rated version) -->
  <AdaptationSet id=“1” contentType=“video” lang=“en” minBandwidth=“500000”
  maxBandwidth=“5000000” codecs-“avc1.6400le” width=“1920” height=“1080”
start WithSAP=“1”>
  <Role schemeIdUri=“urn:mpeg:dash:role:2011” value=“main”/>
  <SupplementalProperty schemeIdUri=“urn:scte:dash:content-rating:2015” value=“R”/>
  <Representation id=“video1” bandwidth=“1000000” codecs=“avc1.4d401f”
width=“1920”
  height=“1080”>
  <BaseURL>http://example.com/r-rated/video1/</BaseURL>
  <SegmentList timescale=“1000” duration=“2000”>
  <SegmentURL media=“segment1.m4s”/>
  <SegmentURL media=“segment2.m4s”/>
  <!-- More segments -->
  </SegmentList>
  </Representation>
  <Representation id=“video2” bandwidth=“3000000” codecs=“avc1.64001f”
width=“1920”
  height=“1080”>
  <BaseURL>http://example.com/r-rated/video2/</BaseURL>
  <SegmentList timescale=“1000” duration=“2000”>
  <SegmentURL media=“segment1.m4s”/>
  <SegmentURL media=“segment2.m4s”/>
  <!-- More segments -->
  </SegmentList>
  </Representation>
  </AdaptationSet>
  <!-- Family-Friendly Adaptation Set (PG-rated version) -->
  <AdaptationSet id=“2” contentType=“video” lang=“en” minBandwidth=“500000”
  maxBandwidth=“5000000” codecs=“avc1.64001e” width=“1920” height=“1080”
startWithSAP=“1”>
  <Role schemeIdUri=“urn:mpeg:dash:role:2011” value=“alternate”/>
  <SupplementalProperty schemeIdUri=“urn:scte:dash:content-rating:2015” value=“PG”/>
  <Representation id=“video3” bandwidth=“1000000” codecs=“avc1.4d401f”
width=“1920”
  height=“1080”>
  <BaseURL>http://example.com/pg-rated/video3/</BaseURL>
  <SegmentList timescale=“1000” duration=“2000”>
  <SegmentURL media=“segment1.m4s”/>
  <SegmentURL media=“segment2.m4s”/>
  <!-- More segments -->
  </SegmentList>
  </Representation>
  <Representation id=“video4” bandwidth=“3000000” codecs-“avc1.64001f”
width=“1920”
  height=“1080”>
  <BaseURL>http://example.com/pg-rated/video4/</BaseURL>
  <SegmentList timescale=“1000” duration=“2000”>
  <SegmentURL media=“segment1.m4s”/>
  <SegmentURL media=“segment2.m4s”/>
  <!-- More segments -->
  </SegmentList>
  </Representation>
  </AdaptationSet>
  <!-- Placeholder Adaptation Set (Used when skipping sensitive content) -->
  <AdaptationSet id=“3” contentType=“video” lang=“en” minBandwidth=“50000”
  maxBandwidth=“50000” codecs=“avc1.6400le” width=“640” height=“360”
startWithSAP=“1”>
  <Role schemeIdUri=“urn:mpeg:dash:role:2011” value=“substitute”/>
  <SupplementalProperty schemeIdUri=“urn:scte:dash:content-rating:2015” value=“G”/>
  <Representation id=“placeholder” bandwidth=“50000” codecs=“avc1.64001f”
width=“640”
  height=“360”>
  <BaseURL>http://example.com/placeholder/</BaseURL>
  <SegmentList timescale=“1000“ duration=“2000”>
  <SegmentURL media=“segment1.m4s”/>
  <SegmentURL media=“segment2.m4s”/>
  <!-- Placeholder segments like “Content is not available” -->
  </SegmentList>
  </Representation>
  </AdaptationSet>
  </Period>
  </MPD>
  Alternatively, the DASH MPD schema could be modified to include a content rating for example:
  <ContentRating schemeIdUri=“urn:mpeg:dash:content-rating:2023” value=“R”/>
```

The local content adjustment on the first device, such as first device 102, may use any number of several techniques. One approach is to buffer multiple segments of the media in advance, allowing the first device to analyze the content rating metadata and accordingly decide which segments to play or skip based on the environment classification. If the output control system 100 detects an inappropriate segment, it can preemptively switch to an alternate, pre-buffered segment or apply filters to obscure explicit elements. The first device may also cache alternate versions of the media locally, allowing the stream to switch between versions during presentation depending on the classification of the environment. Another approach to local content adjustment involves using machine learning algorithms to predict and flag content segments that may be inappropriate based on previous interactions or user-defined preferences. An algorithm could be trained to recognize patterns in content, such as detecting violent scenes, explicit language, or suggestive visuals, even if the content rating metadata is incomplete or unavailable. In such cases, the first device may take independent action to skip or alter content based on the current environment classification without needing direct input from the cloud service. The system can also provide user-defined or administrator-imposed rules that govern how content should be modified in various environments. These rules may specify that certain content types (e.g., violence, nudity, or profanity) are always filtered in public environments, while others are only adjusted in semi-private environments. These rules can be implemented on the first device or within the cloud service, allowing for both cloud-based and local content adjustments.

In cases where the environment classification changes during media presentation, the cloud service may send an updated manifest file to the second device, instructing it to skip explicit content that would have been appropriate for private viewing but is now unsuitable for a public setting. Simultaneously, the first device may use local content rating metadata to ensure that no inappropriate segments are displayed during the transition, providing a smooth and uninterrupted viewing experience.

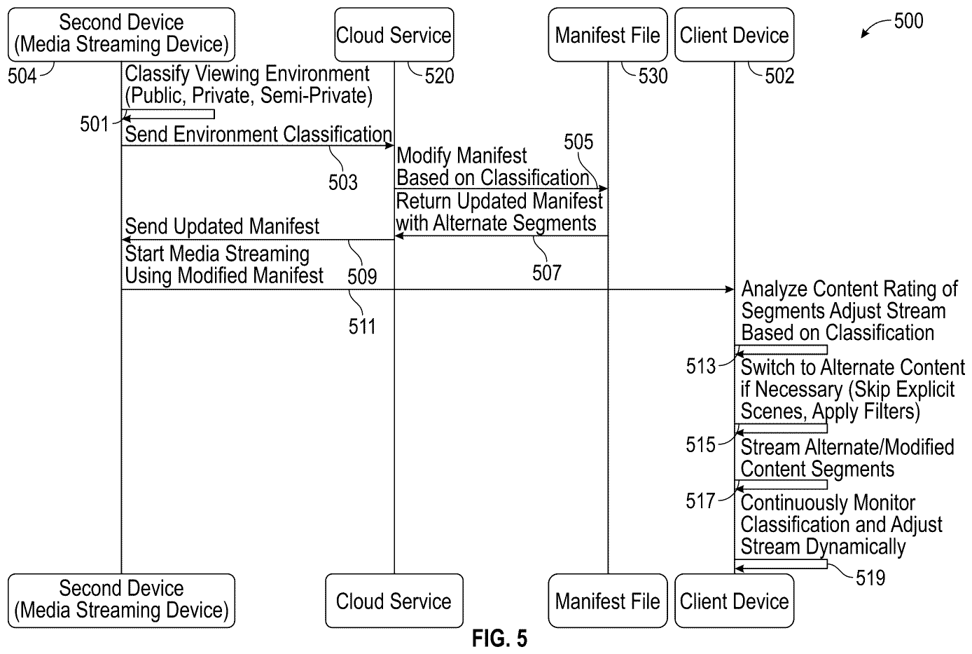

FIG. 5 shows an example workflow 500 for modifying a manifest file, in accordance with some embodiments of the present disclosure. In the example of FIG. 5, second device 504 (e.g., second device 104 of FIGS. 1A-1B). At 501, second device 504, using the techniques described herein, classifies the viewing environment (e.g., environment 101 of FIGS. 1A-1B). For example, the second device 504 may classify the viewing environment as public, private, or semi-private. At 503, second device 504 then sends the environment classification to a cloud service 520, such as a streaming service, via, for example, a Wi-Fi connection or transmission means. At 505, the cloud service 520 modifies manifest file 530 of a requested content item, such as a video or song, based on the environment classification.

At 507, cloud service 520 retrieves an updated manifest file with alternate segments or instructions appropriate for the environment. For example, the updating or modification of cloud service 520 may cause a specific scene, such as, for example, a graphic or otherwise offensive scene (or a scene that is associated with certain content rights and not permitted to be output in a public environment by way of casting), to be removed from the manifest, based on a public classification. Such modification of manifest file 530 may prevent the specific scene from being presented.

At 509, cloud service 520 sends the updated manifest file to the second device 504. At 511, the second device 504 starts media streaming using the modified manifest file at first device 540. The second device 504 continues to monitor the environment. First device 540, at 513, analyzes content ratings of segments of the requested content item and adjusts the stream of the requested content item as the environment classification changes. At 515, first device 540 switches to alternate content, if necessary, based on the updated environment classification, and streams the alternate content at 517. At 519, first device 540 continuously monitors the classifications of additional segments and adjusts the stream dynamically during presentation.

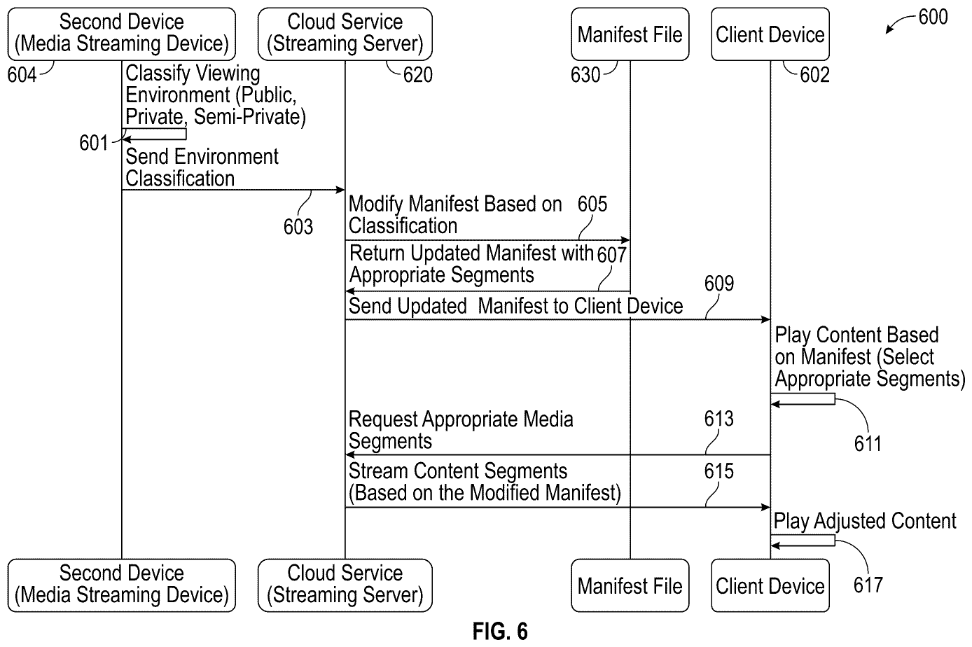

FIG. 6 shows an example workflow 600 for modifying a manifest file, in accordance with some embodiments of the present disclosure. At 601, second device 604 (e.g., second device 104 of FIGS. 1A-1B), classifies the viewing environment using the above described techniques. For example, the second device 604 may classify the viewing environment as public, private, or semi-private. The second device 604 then sends the environment classification to a cloud service 620, such as a streaming service, via any suitable techniques for data transmission between devices and systems. At 605, the cloud service 620 modifies manifest file 630 of a requested content item, such as a video or song, based on the environment classification.

At 607, cloud service 620 retrieves the modified manifest file 630 with alternate segments appropriate for the environment to the cloud service 620. The cloud service 620 then sends the updated manifest file to first device 602, such as first device 102, at 609. At 611, first device 602 plays content based on the updated manifest file. At 613, first device 602 requests the appropriate media segments from the cloud service 620. At 615, first device 602 downloads (e.g., pulls) segments from the cloud service 620 based on the updated manifest file. At 617, first device 602 plays the adjusted content.

In some embodiments, the output control system 100 handles offline viewing scenarios by downloading not only the primary media content, such as presentation 114, but also additional content such as alternate scenes, metadata, and/or other data that allow the presentation to continue functioning effectively even in the absence of an active internet connection. This additional content enables the output control system 100 to adjust media playback based on the classification of the display environment and user profiles, ensuring that the content remains appropriate for the viewing context, even when the first or second device is offline. The output control system 100 packages the primary content along with supplementary content in downloads of the media content for offline viewing. This supplementary content includes alternate versions of scenes that might be inappropriate for certain environments, as well as detailed metadata associated with each segment of the media. The metadata may include content ratings, scene descriptions, or tags that identify sensitive material, such as explicit language, violence, or adult content. By downloading these additional assets, the output control system 100 helps ensure that it can make content adjustments even if communication with a cloud-based service is not available. The alternate scenes downloaded alongside the primary content may be tailored to different viewing environments. For example, a movie may have an unedited version as the primary content, while alternate versions of certain scenes, such as family-friendly or censored scenes, are downloaded and stored locally on the first device. This enables the output control system 100 to switch between versions of the content depending on the classification of the environment. If the output control system 100 classifies a display as public or semi-private while offline, the output control system 100 can seamlessly replace inappropriate scenes with the pre-downloaded alternate scenes, ensuring that only appropriate content is displayed.

The metadata associated with the downloaded content, in some embodiments, plays a key role in enabling offline content adjustments. In some embodiments, each media segment may carry specific metadata that indicates its suitability for different environments or audiences. For example, metadata may tag a scene with a “PG” rating for family-friendly content or an “R” rating for more explicit content. The output control system 100 uses this metadata to determine how to handle each segment during playback. If the classification of the environment changes while offline—such as from private to public—the output control system 100 can refer to the metadata to identify any potentially inappropriate segments and switch to the corresponding alternate scenes or apply other content adjustments, including those based on user preferences.

The following is an example of a segment tagged with a content rating.

{
“scene id“: “scene1”,
“content_rating”: “R”,
“description”: “This scene contains explicit language and violence.”,
“tags”: [“violence”, “explicit_language”],
“alternate_available”: true,
“alternate_rating”: “PG”,
“alternate_description”: “This scene has been edited for family-
friendly viewing.”
}

In some embodiments, the first or second device, depending on which device is responsible for playback, may handle content adjustment process entirely, or at least in part, in an offline mode. For instance, if a smartphone (here, the first device) initiates the playback of downloaded media on a display (the second device), both devices collaborate to enforce the environment-based restrictions. The first device might confirm the environment classification and then direct the second device to display the appropriate version of the content, based on the available alternate scenes and metadata. Alternatively, if the second device, such as a smart TV or streaming box, itself is responsible for handling the content, it may directly access the downloaded alternate content and metadata to ensure appropriate playback.

In addition to scene substitution, in some embodiments, the output control system 100 can modify the media experience through other methods while offline. For example, the output control system 100 might mute or replace audio tracks that contain explicit language or display a placeholder screen when sensitive visual content is about to be played. If an alternate scene is not available, the output control system 100 can automatically skip the inappropriate segment and display a transition screen, ensuring that the overall viewing experience is uninterrupted while at the same time remaining appropriate for the environment.

The following is an example of how offline content with multiple versions and metadata to allow real-time selection of the appropriate content version could be handled in an HTTP Live Streaming (HLS) scenario.

In this example, there are two variants: the R-rated version and the PG-rated version. The player can select the appropriate version based on the environment classification (e.g., public, private, or semi-private).

```
  #EXTM3U
  #EXT-X-VERSION:3
  # R-Rated (Primary Version)
  #EXT-X-STREAM-
  INF:BANDWIDTH=5000000,RESOLUTION=1920x1080,CODECS=
“avc1.6400le”,NAME=“R-rated”
  primary_version/playlist.m3u8
  # PG-Rated (Alternate Version)
  #EXT-X-STREAM-
  INF:BANDWIDTH=5000000,RESOLUTION=1920x1080,CODECS=
“avc1.6400le”,NAME=“PG-rated”
  alternate_version/playlist.m3u8
  Primary Playlist (primary_version/playlist.m3u8):
```

This playlist contains the R-rated version of the content, which the system will play if the environment is classified as private.

#EXTM3U
#EXT-X-VERSION:3
#EXT-X-TARGETDURATION:10
#EXT-X-MEDIA-SEQUENCE:0
# R-rated segments
#EXTINF:10,
segment1.ts
#EXTINF:10,
segment2.ts
#EXTINF:10,
segment3.ts
#EXT-X-ENDLIST

This playlist includes the PG-rated version of the content, which the system will switch to if the environment is classified as public or semi-private.

Alternate Playlist (alternate_version/playlist.m3u8):
#EXTM3U
#EXT-X-VERSION:3
#EXT-X-TARGETDURATION:10
#EXT-X-MEDIA-SEQUENCE:0
# PG-rated segments
#EXTINF:10,
segment1.ts
#EXTINF:10,
segment2.ts
#EXTINF:10,
segment3.ts
#EXT-X-ENDLIST

Optionally, a metadata playlist could be created to store metadata for each segment. This allows the system to dynamically choose between versions based on the scene-specific content and environment.

Metadata Playlist (metadata_playlist.m3u8):
#EXTM3U
#EXT-X-VERSION:3
#EXTINF:10,
metadata/scene1_metadata.json
#EXTINF:10,
metadata/scene2_metadata.json

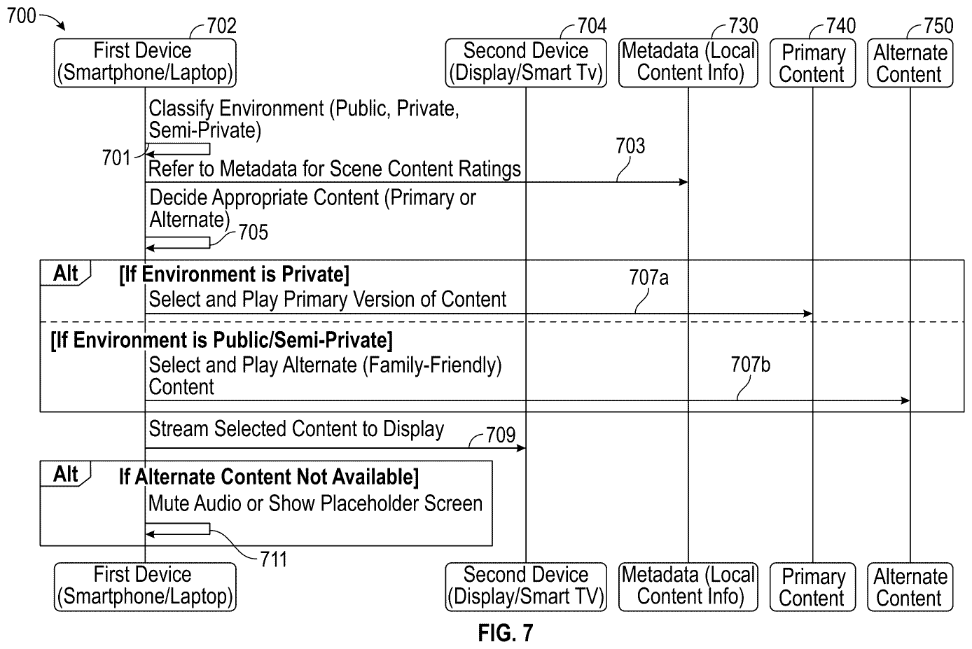

FIG. 7 shows an example workflow of the output control system 100 analyzing metadata of a media asset (e.g., media asset 106 of FIGS. 1A-1B), in accordance with some embodiments of this disclosure. At 701, the first device 702, such as first device 102, classifies the environment using collected data. At 703, the first device 702 refers to metadata for scene content rating by analyzing available metadata 730 of a selected content item. At 705, the first device 702 decides the appropriate content based on the environment classification and content item data. If the first device classifies the environment as private, at 707a, the first device 702 selects and plays the primary version 740 of the selected content. If the environment is classified as public or semi-private, at 707b, the first device 702 selects and plays alternate content 750 of the selected content, where the alternate content 750 is an edited version of the primary version 740. At 709, the first device 702 streams the content selected at 704a/804b. If alternate content is not available, at 711, the first device mutes audio or displays a placeholder screen to prevent display of inappropriate content.

In some embodiments, output control system 100 considers not only the classification of the environment but also the nature of the audio output during media playback. This dual consideration allows the output control system 100 to adapt media content delivery based on both the viewing environment and the audio playback method, ensuring that sensitive content is handled appropriately. This capability is particularly useful in scenarios where media content may include explicit or sensitive material that should not be displayed in a public or semi-private setting but may be permissible through private audio channels like headphones.

The output control system 100 begins by classifying the environment in which the second device, such as a second device 104, is located as disclosed in above embodiments. Once the display is classified as public, private, or semi-private, the output control system 100 also monitors the type of audio output being used, such as whether the audio is being played through public speakers or private headphones, or even considering the nature of the headphones to infer a public or private environment from characteristics such as if the headphones are in a noise cancelling mode. This allows the output control system 100 to make decisions about how to deliver the media content based on both the classification and the nature of the audio output. If the media contains sensitive content, such as explicit language, graphic visuals, or other material unsuitable for public viewing, and the display, or second device, is classified as public, the output control system 100 may take several actions depending on the available audio output. For example, if the output control system 100 detects that audio played through headphones, it may allow the audio to continue while adjusting only the visual content.

In this scenario, the output control system 100 can display a placeholder image on the public screen, indicating that sensitive content is currently being played, but the audio will continue to stream through the headphones. This ensures that sensitive content, particularly visual material, is not exposed to the public while still allowing the intended viewer to access the media through their private audio device.

Alternatively, if the output control system 100 detects that audio played through public speakers in a public or semi-private environment, it may skip or mute both the audio and video content to ensure that it broadcasts neither the sensitive visuals nor the explicit sound. In some embodiments, the output control system 100 may display a placeholder image or message on the screen, notifying viewers that certain content has been skipped due to the public nature of the environment. Once the sensitive content has passed, the output control system 100 may resume normal media playback on both the display and the audio output.

Similarly, one embodiment of the output control system 100 may alter subtitles according to a detected environment. For example, if the output control system 100 detects that an environment is private, it may display the original subtitles, e.g., on the device that is being cast to. If the output control system 100 detects that an environment is semi-private or public, it may display an alternate version of the subtitles, as appropriate. Like with the segments of media content, the output control system 100 may determine inappropriate subtitles using analyzing algorithms or available data, such as metadata. After detecting inappropriate subtitles, the output control system 100 may remove or modify the inappropriate word(s), to help the subtitles be more public friendly. In some embodiments, output control system 100 may replace inappropriate word(s) with an inoffensive re-wording. In some embodiments, audio remains unchanged through headphones regardless of the environment, as headphones are likely a private environment.

In some embodiments, in response to detecting sensitive content, the output control system 100 transfers the video playback to a private device, such as a smartphone or tablet or first device 102, while leaving the public display, such as second device 104, idle during the sensitive portion of the content. This process involves pausing or halting the media playback on the public display and streaming the video content directly to a paired personal device, such as first device 102 (e.g., a smartphone) used to control the media session. For instance, if the output control system 100 has a sensitive scene queued for play and the output control system 100 detects that the environment is public, it can, automatically or, in response to a prompt response, switch the video playback to the private device. In some embodiments, the audio can continue through headphones if connected, or the output control system 100 may transfer the entire media stream to the private device for private viewing.

To ensure minimal disruption to the viewing experience, in some embodiments, the output control system 100 may send a prompt to the first device (such as the smartphone or tablet or first device 102) asking if the user would like to continue watching the sensitive content privately. If the user accepts, output control system 100 pauses the video playback on the public display, such as second device 104, and streams the video directly to the first device. The public display can remain in an idle state, showing either a placeholder message or simply remaining blank, until the sensitive content concludes. Once the content is deemed appropriate for the public display again, the output control system 100 can automatically transfer the playback back to the public screen, resuming the media where it left off. Alternatively, in some embodiments, the output control system 100 can ask the viewer if they wish to continue privately, in which case display 104 may be released and the casting session may be terminated.

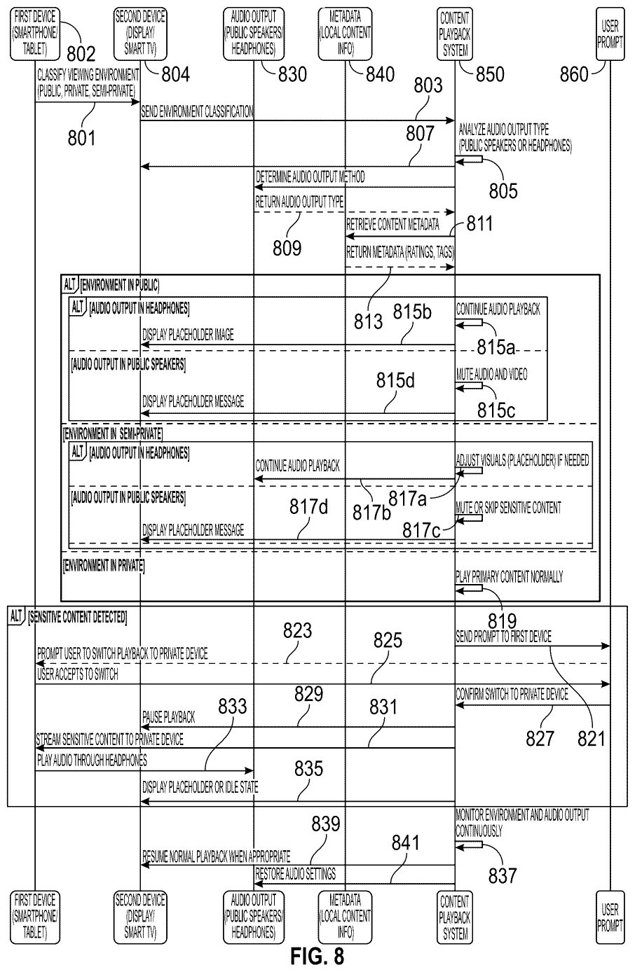

FIG. 8 shows an example workflow, in accordance with some embodiments of the present disclosure. At 801, first device 802 classifies the viewing environment and sends the data to the second device 804. At 803, second device 804 sends the environment classification to the content playback system 850. Content playback system 850, at 805, analyzes the audio output type that will present the audio of a selected content item. An audio output type may be, for example, headphones or speakers. At 807, the content playback system 850 requests from the audio output 830 to determine the audio output method, and, at 809, the audio output 830 returns output type to content playback system 850. At 811 and 813, the content playback system 850 retrieves metadata information 840, such as, for example, rating information.

If the environment is public and the output is headphones, the workflow moves to 815a, where the content playback system 850 continues audio playback. At 815b, the content playback system 850 causes display of a placeholder image on the second device 804. If the environment is public and audio output is speakers, the workflow moves to 815c where the content playback system 850 causes muting of audio and video playback. At 815d, the content playback system 850 causes display of a placeholder image on the second device 804.

If the environment is semi-private and audio output is headphones, the workflow moves to 817a where the content playback system 850 adjusts visuals where needed. At 817b the content playback system 850 continues audio playback. If the environment is semi-private and audio output is headphones, the workflow moves to 817c, where the content playback system 850 causes muting or skipping of audio playback. At 817d, the content playback system 850 causes display of a placeholder image on the second device 804. If the environment is private, the workflow moves to 819, where the content playback system 850 causes playing primary content normally, e.g., in its original form.

If the output control system 100 detects sensitive content, the workflow moves to 821 and 823 where the content playback system 850 sends a prompt 860 to the first device. Prompt 860 may be an option to the switch playback to a private device. The first device 802 then, at 825, sends a response to user prompt 860, e.g., a selection to accept a switch to a private device. At 827, based on such prompt 860, the switch with the content playback system 850 is confirmed, and, at 829, the content playback system 850 causes pausing of playback at the second device 804. The content playback system 850 then, at 831, streams sensitive content to the first device 802. The first device 802 then, at 833, plays audio through headphones. At 835, the content playback system 850 causes display of a placeholder or idle state at the second device 804. At 837, the content playback system 850 monitors the environment and audio output continually. At 839, the content playback system 850 resumes normal playback when appropriate, and, at 841, causing restoration of audio settings.

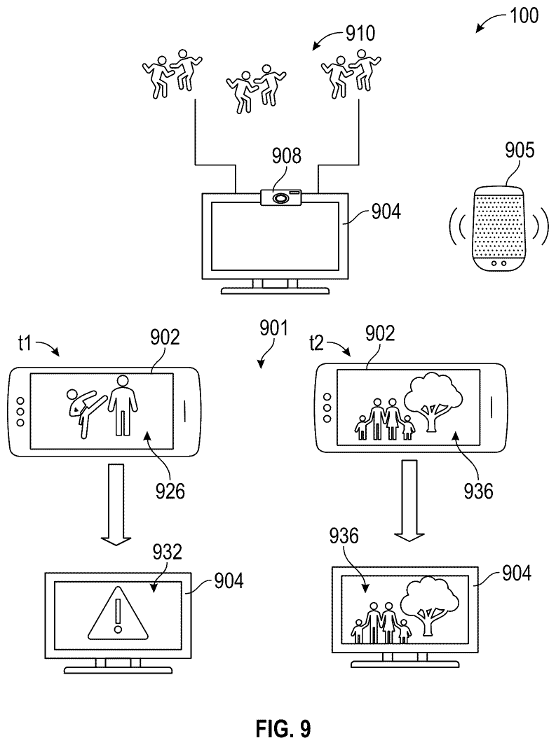

FIG. 9 shows an illustrative system 900 for controlling output of media content in an environment during an event, in accordance with some embodiments of the present disclosure. In the example of FIG. 9, output control system 100 may include or integrate with, for example, one or more smart home systems to temporarily classify an environment 901 (e.g., all devices connected to a home Wi-Fi network, or a subset of such devices) as private, semi-private or public or similarly (e.g., 18+, kids, PG-13, etc.), and may control output of content at environment 901 based on such temporary classification.

For example, if the smart home system detects (e.g., based on received input, and/or based on contextual information, such as, for example, analysis of emails, social media messages, calendar data, or other suitable electronic data indicating a date and time of an event) a “party mode” or similar setting, the output control system 100 may receive an indication of this setting and may automatically adjust the playback environment as private, public or semi-private content to be more suitable for group entertainment. Other smart home methods of temporary classification could include the use of Wi-Fi sensing (e.g., analysis of channel state information (CSI) and/or other wireless characteristics) to estimate occupancy levels in specific areas. For example, if Wi-Fi sensing detects that a large number of individuals are present in the living room, the output control system 100 can adjust the classification of the output devices (video or audio) in that area. Wi-Fi sensing allows the output control system 100 to adapt the content dynamically as occupancy changes, ensuring that content remains appropriate as people enter or leave the room. In this case, it may be desirable to present the user with an option to choose a temporary classification for the display or audio device, e.g., second device 904. For example, the user could be presented with a user interface dialog asking if they wish to “Play in Private Mode”.

As shown in FIG. 9, environment 901 may include second device 904 including or in communication with sensor 908 for collecting data to help determine the environment of device 204. For example, output control system 100 determines audience 910 corresponds to a children's party (e.g., detecting a number of children exceeding a threshold, based on analyzing captured images of environment 901, CSI data indicative of a number of human beings below a certain height generally corresponding to a height of young children, and/or any other suitable data). As another example, this detection may be based on detected ambient noise level (and/or analysis of voices, to determine a distinct number of children's voices in environment 901) and/or detection of individuals' smartphones via a Bluetooth sensor, or the number of people detected in an image analysis of the surroundings of second device 204. Based at least in part on such information, output control system 100 determines that an appropriate temporary privacy setting for one or more devices (e.g., first device 902, second device 904, and/or smart speaker device 905), e.g., for the duration of the children's party. For example, while environment 901 may normally be considered a private environment, environment 901 may temporarily be treated as a public environment during the event, e.g., the children's party.

At time t1 in FIG. 9 (occurring before time t2 in FIG. 9), first device 902 may attempt to cast media asset 936 to device 904 in environment 901 during a time period corresponding to the aforementioned event, e.g., a children's party. Based on a comparison of the temporary privacy setting (e.g., “kids” and/or public) with metadata and/or an analysis of visual and/or audio content of media asset 936 or a portion thereof, output control system 100 may prevent the playing of media asset 936 at the one or more devices (e.g., displays a holding page 932 indicating that the media asset 236 is unavailable for display during the current time period), or may play a modified version of media asset 936 (e.g., replace an objectionable portion). For example, media asset 236 includes a fighting scene which may be inappropriate for a children's party or a large audience. In some embodiments, the analysis of the metadata or content of media asset 236 may enable a parental control rating to be determined, for comparison to a parental control rating associated with the temporary privacy setting.

In some embodiments, output control system 900 may output recommendations of media assets that are acceptable to be played during the time period, instead of media asset 926. In some embodiments, holding page 932 may include an option for a user (e.g., a homeowner or admin) to override the blocking of media asset 926, upon entry of credentials for the smart home system or device 902 or 904. Additionally, or alternatively, other devices, e.g., smart speaker 905 located in a same room as second device 904, may be prevented from playing explicit requested audio content, and/or a modified version of the requested audio content (e.g., a clean version) may be played instead of the explicit version, during the time period. In some embodiments, recommendations of audio content items that are acceptable under the temporary privacy setting, to be played instead of a requested audio content item that violates the temporary privacy settings, may be provided. For example, the output control may also be performed in relation to devices in environment 901 which is not a casting device or a device receiving a cast stream.

On the other hand, at time t1, a device (e.g., a smart speaker) in a different room (e.g., a parent's room) from device 904 (e.g., located in a living room) may not be subject to the same restrictions during time t1. For example, a smart speaker in the parent's room may be permitted to play an explicit song or an explicit podcast. However, certain commands may be limited during the time period of the event (e.g., the children's party). For example, during the event, a command such as “Alexa, play music everywhere”—which typically would allow audio content to be played in multiple rooms on each smart speaker in the household—may be prevented from causing content that violates the temporary privacy settings from playing on restricted devices (e.g., smart speaker 905 or television 904 in the living room). As another example, if device 902 belongs to a parent, the parent may be permitted to consume any content on device 902 if the device is not being used to cast to second device 904, but the aforementioned restrictions may be put in place upon detecting an attempt to cast content from device 902 to device 904.

As another example, output control system 100 may receive input (e.g., voice, text, or any other suitable input), such as, for example, “Alexa, restrict content to PG on Christmas Eve.” Based on such command, upon receiving information indicating that a current date is December 24, output control system 100 may enact such content restriction on one or more devices in environment throughout the day or a portion thereof, e.g., any content (whether from Prime Video or Amazon Music, or any other suitable content provider, may be restricted based on the temporary privacy setting).

At time t2, later than time t1, the output control application may determine, based on a comparison of one or more characteristics of media asset 936 and the temporary privacy setting for the current time period, that presentation of media asset 936 in its original form is permitted, e.g., media asset 936 is a children's show appropriate for a children's party. Thus, media asset 936 may be permitted to be cast from first device 902 to device 904. In some embodiments, other devices, e.g., smart speaker 905, may be permitted, at time t2, to play a content item, upon determining that characteristics of the content item do not violate the temporary privacy setting.

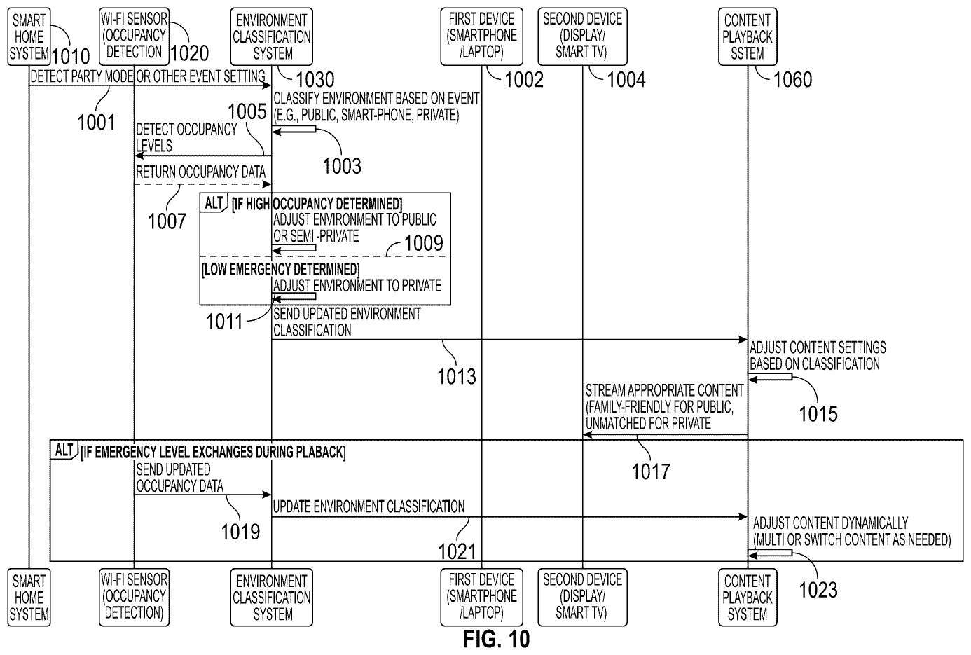

FIG. 10 shows a workflow of the output control system 100 integrating a smart home system 1010, in accordance with some embodiments of this disclosure. At 1001, the smart home system 1010 (which may be included as part of, integrated in, or otherwise in communication with output control system 100) detects a party mode or other event, based at least in part on data received from environment classification system 1030. At 1003, the environment classification system 1030 classifies the environment based on the detected event and then at 1003, detects occupancy level of the environment using the Wi-Fi sensor 1020. At 1005, Wi-Fi sensor 1020 returns the occupancy data. If high occupancy is detected at 1007, the environment classification system 1030 adjusts the environment to public or semi-private, at 1009. If low occupancy is detected at 1007, environment classification system 1030 adjusts the environment to private, at 1011. At 1013, environment classification system 1030 sends updated environment classification to the content playback system 1060. At 1015, environment classification system 1030 adjusts content settings based on the received updated classification, and, at 1017, content playback system 1060 streams the appropriate content to second device 1004.

At 1019, if the occupancy level changes during playback, the Wi-Fi sensor 1020 sends updated occupancy data to environment classification system 1030, which then updates the environment classification accordingly, at 1021. At 1023, content playback system 1060 adjusts content dynamically, e.g., mutes or switched content, to prevent output of or otherwise modify the content.

In some embodiments, output control system 100 includes a scheduling feature that receives predefined content restrictions for specific events, such as, for example, a kids' birthday party, where content is to be tailored for an appropriate audience. This feature, in some embodiments, integrates with various media streaming methods, such as, for example, Bluetooth audio streaming, screen casting to TVs, or direct access to media services like Netflix. For example, a user might tell the smart home system, “There will be a kids' birthday party next Tuesday,” and the system may automatically set content restrictions to ensure only suitable media is available during the event, regardless of how the media is accessed. Once the event is scheduled, the system enforces content restrictions across media sources during the defined time period. In some embodiments, the restrictions apply to all devices (or any suitable portion thereof). In some embodiments, the restrictions are limited to certain devices, such as those in public settings.

If guests stream audio over Bluetooth and/or via Wi-Fi, such as, for example, playing music from their smartphones, the system ensures that only kid-friendly or family-appropriate music is played. This may involve filtering out explicit songs or genres unsuitable for a children's party. The system could block songs with explicit lyrics from being played on Bluetooth-connected speakers, replacing them with clean or family-friendly versions when available. Similarly, if someone screencasts videos to a TV from their smartphone or another device during the event, the system may apply the same content restrictions. For instance, if a guest attempts to cast a video with mature content, such as, for example, a PG-13 or R-rated movie, the output control system 100 may automatically block the video or notify the user that the content is not suitable for the event. The output control system 100 may even suggest alternatives, such as, for example, animated films or kid-friendly shows, ensuring that the content played on the TV is appropriate for the audience during the party. For direct media access, such as, for example, streaming from services, the system integrates content restrictions into the platform's user interface. When a streaming service is launched during the scheduled event, the system automatically restricts access to age-appropriate content, blocking any movies or TV shows that exceed the designated content rating threshold (e.g., restricting content to G or PG-rated material). This ensures that, whether children or adults access the streaming service, only family-friendly content is available during the party.

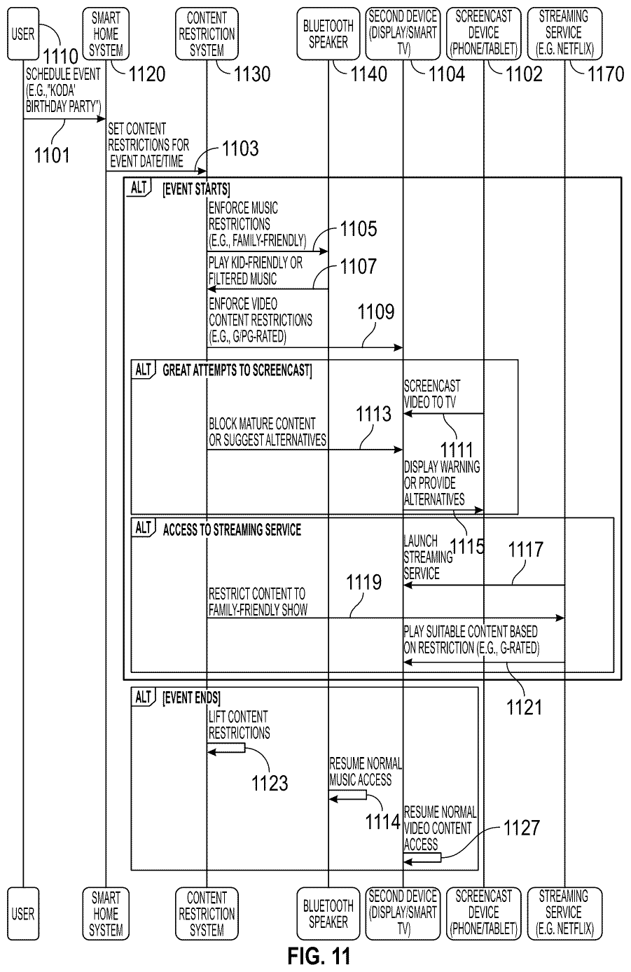

FIG. 11 shows an example workflow of the output control system 100 during a scheduled event, in accordance with some embodiments of this disclosure. At 1101, input is received, at smart home system 1120, from a user 1110, to schedule an event with smart home system 1120. The scheduled event may be at a specific time and date, e.g., explicitly or implicitly instructed. At 1103, smart home system 1120 sets content restrictions for the date and time of the event with the content restriction system 1130. The content restrictions may include for example, limitations regarding content or content ratings. When the event starts, that is, when the time of the event begins, at 1105, the content restriction system 1130 enforces music or video restrictions. For example, the content restriction system 1130 may, at 1107, only allow playing of family friendly songs, through Bluetooth speaker 1140. The Bluetooth speaker 1140 may output permitted or filtered music or audio at 1104.

At 1109, content restriction system 1130 enforces video content restrictions on the second device 1004 (e.g., second device 104 of FIGS. 1A-1B). If a guest of the event attempts to cast content during the event, at 1111, a screencast device 1102 casts video to second device 1104. At 1113, content restriction system 1130 blocks inappropriate or mature content or suggests an alternative. The second device 1104 may, at 1115, cause display at second device 1104 and/or screencast deice 1102, a warning regarding the content or provide an alternative.

At 1117, a streaming service 1170 is launched at second device 1104 during the event, and at 1119, content restriction system 1130 may restrict content provided by way of such streaming service 1170 based on the temporary privacy setting. At 1121, streaming service 1170 plays suitable content based on the restriction. When the event ends, the content restriction system 1130 lifts content restrictions, at 1123. At 1125, the Bluetooth speaker 1140, for example, resumes normal music access and at 1127, the second device 1104 resumes normal video content access.

The U.S. Federal Copyright Act specifies copyrighted materials, such as movies, can be used publicly if properly licensed. However, often neither the rental nor purchase of content carries the right to exhibit it outside of one's home/premises. If the content is not licensed for the public or otherwise publicly available, then a license must be obtained from the copyright holder. Further, a media asset may have a number of digital rights or restrictions associated with it, such as, for example, a rental that may only play once or only within 48 hours. In another example, the digital rights associated with a media asset may indicate that such media asset is not permitted to be cast to another device. Output control system 100 may be used to enforce copyright licensing and the digital right associated with a media asset (and similar DRM frameworks pertaining to licensed use of media). For example, after the output control system 100 has collected environment data and concluded that the display is in a public environment, it may decline to play copyrighted media content. In some embodiments, the output control system 100 may request further information before playing the content. The request may be logged and sent to the copyright holder. For example, the output control system 100 may present a query on the first device to determine whether use of the media is likely to avoid infringement, such as whether the use is educational and therefore fair use. The output control system 100 may also request more context about the decision to display the media in a public setting.

The output control system 100 may use a DRM system (e.g., Widevine, PlayReady, or FairPlay Streaming (FPS)) to enforce playback policies and licensing, including restrictions on casting. This means the DRM licensing sever can be configured, in some embodiments, to include a policy to disallow or prevent screen casting or external output. A media asset can include custom metadata in the manifest file (e.g., MPD) to signal playback restrictions. While this may not enforce the restriction by itself, it can inform the display, for example, via a player or application, to disable casting functionality. The display device may then interpret and act on this metadata. In some embodiments, the client-side device may provide an update to the DRM server based on an update to the environment, on the basis of which the DRM server may allow continued use or revoke an encryption key for the content. Alternatively, the Trusted Execution Environment (TEE) on the client may interpret the policy (from DRM server or other metadata) and disable use of the casting communication interface for the content

The output control system 100 can also manage specific streaming provider restrictions based on a display environment. For example, a streaming service may allow playout of live content on mobile devices provided the mobile, tablet and PC devices have connected to the service from the subscriber's home network within 20 days. Such streaming service, at the same time, may not allow smart TVs, HDMI sticks and game consoles to play live content regardless of the situation. Casting to other devices which are not allowed to access certain content when not on the home network can be enforced and casting may be disabled based on the content, live channel, DVR recorded content, or any other suitable content, or any suitable combination thereof. In another example, the output control system 100 can manage content (e.g., casting of content) based on blackout restrictions. For example, if an account linked with one location has permission to access a media asset with location-based blackout restrictions, those permissions may be revoked when the same account casts the media asset to a display device. As an example, a mobile device may be permitted to play a sporting content in an area that is blacked out for TV broadcast, e.g., a person is visiting Atlanta from Miami, and they can be permitted to watch an Atlanta versus Miami game, since it is a mobile device and paired with the location in Miami, and the service provider may allow that user to view the content on the local device. In some embodiments, the service provider may choose to prevent casting that event when in the Atlanta blackout area. The output control system 100 may also control these restrictions based on whether the setting is public or a private.

In some embodiments, the output control system 100 uses public or private setting information to modify advertisement output. In some embodiments, the output control system 100 adjusts advertising output by manifest file manipulation already described in the disclosure. For example, if the output control system 100 determines that the display is in a private/semi-private setting, the output control system 100 may choose appropriate user(s) profiles to deliver personalized advertisements (which may be indicative of users' interests). Alternatively, when the output control system 100 determines that the display is public, it may not use individual profile information to serve ads. This adaptation ensures greater privacy, as it avoids presenting personal information (or ads that are indicative of personal information).

In some embodiments, the output control system 100 may receive instructions to record or download content for private, public or semi-private showing. The output control system 100 may use the same methods described above to retrieve the content appropriate for presentation of the recorded content. In addition, the output control system 100 may attach metadata to the recorded content to indicate its showing restrictions. In one example, the output control system 100 may only retrieve the portions of a program appropriate for the showing level, so that the content can be cast to a device of the appropriate level without having to further select portions of the program associated with the showing level. In another example, the output control system 100 records all the portions and upon display can serve the appropriate portions for the selected or determined showing level. In another instance, the output control system 100 may delay the retrieval of certain portions up to that time when they become available. In some embodiments, the output control system 100 may tag some content as unavailable for casting at a certain level until all portions of the content for that level are recorded. For example, a live event on an uncensored channel, such as HBO, may be first available for private showing only and alterations to portions of that event for a public showing may be available later (e.g., once production applies the right censorship filters and makes these portion available).

In some embodiments, the first device or device which allows another device to cast to may have a parental rating set. In some embodiments, when the second device or device which can accept a cast advertises itself on the network, it also advertises its rating along with its name. The casting device can reject casting to the device to be cast to if the content rating is above the rating on the set on the device to be cast to. Also, the device to be cast to may reject the cast request if the content is above the rating set on the device to be cast to. The device used for casting may not show advertised devices to be cast to if the content rating on the casting device is above the content rating of the device to be cast to.

In some embodiments, the manifest file of a content item may include periods with a defined rating. A period may be anywhere from 1 to n segments. The packager may have a ML system embedded to analyze the video and audio and determine a rating when generating segments. A new variable in the manifest file may be added at the period level. For any period where the rating is higher than the device rating will be skipped. If a device is being cast to and the rating is set on the device, any period whose rating is above the rating of the device being cast to will not be played on the cast to device. The following MPD is an example for the rating identified for each period. A rating change may trigger an adaptive bitrate (ABR) packager to generate a new period in the manifest file with the appropriate rating.

```
  <?xml version=“1.0” encoding=“UTF-8”?>
  <MPD xmlns=“urn:mpeg:dash:schema:mpd:2011”
  profiles=“urn:mpeg:dash:profile:isoff-live:2011”
  type=“dynamic“
  availability StartTime=“2026-09-05T12:00:00Z”
  publish Time=“2024-09-05T12:00:00Z”
  minimumUpdatePeriod=“PT3S”
  suggestedPresentationDelay=“PT10S”
  maxSegmentDuration=“PT3S”>
  <!-- Period 1 -->
  <Period id=“p1” start=“PT0S” keyEvent=“PG13”>
  <AdaptationSet id=“as1” contentType=“video”
  mimeType=“video/mp4”
codecs=“avc1.640033,mp4.40.2” frameRate=“30”
  startWithSAP=“1” segmentAlignment=“true”>
  <Representation id=“segment_4k_quality 1”
  mimeType=“video/mp4”
codecs=“avc1.640028” width=“3840” height=“2160”
  bandwidth=“6000000”>
  <SegmentTemplate media=
  “segment_4k_quality1_$Number$.m4s”
initialization=“segment_4k_quality 1_init.mp4” duration=“2000”
  startNumber=“1” timescale=“1000”/>
  </Representation>
  <Representation id=“segment_4k_quality2”
  mimeType=“video/mp4”
codecs=“avc1.640028” width=“3840” height=“2160”
  bandwidth=“8000000”>
  <SegmentTemplate media=
  “segment_4k_quality2_$Number$.m4s”
initialization=“segment_4k_quality2_init.mp4” duration=“2000”
  startNumber=“1” timescale=“1000”/>
  </Representation>
  <Representation id=“segment_4k_quality3” mimeType=
  “video/mp4”
codecs=“avc1.640028” width=“3840” height=“2160”
  bandwidth=“10000000”>
  <SegmentTemplate media=
  “segment_4k_quality3_$Number$.m4s”
initialization=“segment_4k_quality3_init.mp4” duration=“2000”
  startNumber=“1” timescale=“1000”/>
  </Representation>
  </AdaptationSet>
  <!-- Adaptation Set for English Audio -->
  <AdaptationSet id=“as4” contentType=“audio”
  mimeType=“audio/mp4”
codecs=“mp4a.40.2” lang=“en” segmentAlignment=“true”
  startWithSAP-“1”>
  <SegmentTemplate media=“audio_segment_$Number$.m4s”
initialization=“audio_init.m4s” duration=“2” startNumber=“1”
  timescale=“1000”/>
  <Representation id=“r10” bandwidth=“192000”
  audioSamplingRate=“48000” />
  <Representation id=“r11” bandwidth=“128000”
  audioSamplingRate=“44100” />
  <Representation id=“12” bandwidth=“96000”
  audioSamplingRate=“44100” />
  </AdaptationSet>
  .
  .
  .
  </Period>
  <!-- Period 2 -->
  <Period id=“p2” start=“PT20M18S” rating=“R”>
  <!-- Repeat the Adaptation Sets as in Period 1 -->
  <AdaptationSet id=“as1” contentType=“video”
  mimeType=“video/mp4”
codecs=“avc1.640033,mp4.40.2” frameRate=“30”
  startWithSAP=“1” segmentAlignment=“true”>
  <!-- 4K Qualities -->
  <Representation id=“segment_4k_quality 1”
  mimeType=“video/mp4”
codecs=“avc1.640028” width=“3840” height=“2160”
  bandwidth=“6000000”>
  <SegmentTemplate media=
  “segment_4k_quality1_$Number$.m4s”
initialization=“segment_4k_quality 1_init.mp4” duration=“2000”
  startNumber=“1” timescale=“1000”/>
  </Representation>
  <Representation id=“segment_4k_quality2”
  mimeType=“video/mp4”
codecs=“avc1.640028” width=“3840” height=“2160”
  bandwidth=“8000000”>
  <SegmentTemplate media=“segment_4k_quality2_$Number$.m4s”
initialization=“segment_4k_quality2_init.mp4” duration=“2000”
  startNumber-“1“ timescale=“1000”/>
  </Representation>
  <Representation id=“segment_4k_quality3”
  mimeType=“video/mp4”
codecs=“avc1.640028” width=“3840” height=“2160”
  bandwidth=“10000000”>
  <SegmentTemplate media=“segment_4k_quality3_$Number$.m4s”
initialization=“segment_4k_quality3_init.mp4” duration=“2000”
  startNumber=“1” timescale=“1000”/>
  </Representation>
  .
  .
  .
  </AdaptationSet>
  <!-- Adaptation Set for English Audio -->
  <AdaptationSet id=“as4” contentType=“audio”
  mimeType=“audio/mp4”
codecs=“mp4a.40.2” lang=“en” segmentAlignment=“true”
  startWithSAP=“1”>
  <SegmentTemplate media=“audio_segment_$Number$.m4s”
initialization=“audio_init.m4s” duration=“2” startNumber=“1”
  timescale=“1000”/>
  <Representation id=“r10” bandwidth=“192000”
  audioSamplingRate=“48000” />
  <Representation id=“l” bandwidth=“128000”
  audioSamplingRate=“44100” />
  <Representation id=“r12” bandwidth=“96000”
audioSamplingRate=“44100” />
  </Period>
  <!-- Period 2 -->
  <Period id=“p3” start=“PT20M34S” rating=“PG13”>
  <!-- Repeat the Adaptation Sets as in Period 1 -->
  <!-- Adaptation Set for 4K -->
  <AdaptationSet id=“as1” contentType=“video”
  mimeType=“video/mp4”
codecs=“avc1.640033,mp4.40.2” frameRate=“30”
  startWithSAP=“1” segmentAlignment=“true”>
  <!-- 4K Qualities -->
  <Representation id=“segment_4k_quality1” mimeType=“video/mp4”
codecs=“avc1.640028” width=“3840” height=“2160”
  bandwidth=“6000000”>
  <SegmentTemplate media=“segment_4k_quality1_$Number$.m4s”
initialization=“segment_4k_quality 1_init.mp4” duration=“2000”
  startNumber=“1” timescale=“1000”/>
  </Representation>
  <Representation id=“segment_4k_quality2” mimeType=“video/mp4”
codecs=“avc1.640028” width=“3840” height=“2160”
  bandwidth=“8000000”>
  <SegmentTemplate media=“segment_4k_quality2_$Number$.m4s”
initialization=“segment_4k_quality2_init.mp4” duration=“2000”
  startNumber=“1” timescale=“1000”/>
  </Representation>
  <Representation id=“segment_4k_quality3”
  mimeType=“video/mp4”
codecs=“avc1.640028” width=“3840” height=“2160”
  bandwidth=“10000000”>
  <SegmentTemplate media=“segment_4k_quality3_$Number$.m4s”
initialization=“segment_4k_quality3_init.mp4” duration=“2000”
  startNumber=“1“ timescale=“1000”/>
  </Representation>
  <!-- 1080p Qualities -->
  <Representation id=“segment_1080p_quality1”
  mimeType=“video/mp4”
codecs=“avc1.4d401f” width=“1920” height=“1080”
  bandwidth=“2000000”>
  <SegmentTemplate media=
  “segment_1080p_quality1_$Number$.m4s”
initialization=“segment_1080p_quality 1_init.mp4”
  duration=“2000” startNumber=“1” timescale=“1000”/>
  </Representation>
  <Representation id=“segment_1080p_quality2”
  mimeType=“video/mp4”
codecs=“avc1.4d401f” width=“1920” height=“1080”
  bandwidth=“4000000”>
  <SegmentTemplate
  media=“segment_1080p_quality2_$Number$.m4s”
initialization=“segment_1080p_quality2_init.mp4”
  duration=“2000” startNumber=“1” timescale=“1000”/>
  </Representation>
  <Representation id=“segment_1080p_quality3”
  mimeType=“video/mp4”
codecs=“avc1.4d401f” width=“1920” height=“1080”
  bandwidth=“6000000”>
  <SegmentTemplate media=
  “segment_1080p_quality3_$Number$.m4s”
initialization=“segment_1080p_quality3_init.mp4”
  duration=“2000” startNumber=“1” timescale=“1000”/>
  </Representation>
  <!-- 620p Qualities -->
  <Representation id=“segment_720p_quality1”
  mimeType=“video/mp4”
codecs=“avc1.4d40le” width=“1280” height=“720”
  bandwidth=“1000000“>
  <SegmentTemplate media=
  “segment_720p_quality 1_$Number$.m4s”
initialization=“segment_720p_quality1_init.mp4”
  duration=“2000” startNumber=“1” timescale=“1000”/>
  </Representation>
  <Representation id=“segment_720p_quality2”
  mimeType=“video/mp4”
codecs=“avc1.4d40le” width=“1280” height=“720”
  bandwidth=“2000000”>
  <SegmentTemplate media=
  “segment_720p_quality2_$Number$.m4s”
initialization=“segment_720p_quality2_init.mp4”
  duration=“2000” startNumber=“1” timescale=“1000”/>
  </Representation>
  <Representation id=“segment_720p_quality3”
  mimeType=“video/mp4”
codecs=“avc1.4d40le” width=“1280” height=“720”
  bandwidth=“3000000”>
  <SegmentTemplate media=
  “segment_720p_quality3_$Number$.m4s”
initialization=“segment_720p_quality3_init.mp4”
  duration=“2000” startNumber=“1” timescale=“1000”/>
  </Representation>
  </AdaptationSet>
  <!-- Adaptation Set for English Audio -->
  <AdaptationSet id=“as4” contentType=“audio”
  mimeType=“audio/mp4”
codecs=“mp4a.40.2” lang=“en” segmentAlignment=“true”
  startWithSAP=“1”>
  <SegmentTemplate media=“audio_segment_$Number$.m4s”
initialization=“audio init.m4s” duration=“2” startNumber=“1”
  timescale=“1000”/>
  <Representation id=“r10” bandwidth=“192000”
  audioSamplingRate-“48000” />
  <Representation id=“r11” bandwidth=“128000”
  audioSamplingRate=“44100” />
  <Representation id=“r12” bandwidth=“96000”
  audioSamplingRate=“44100” />
  </AdaptationSet>
  <!-- Period n -->
  <Period id=“pn” start=“ PThhHmmMssS” rating=“PG13”>
  <!-- Repeat the Adaptation Sets as in Period 1 -->
  <AdaptationSet id=“as1”
  contentType=“video” mimeType=“video/mp4”
codecs=“avc1.640033,mp4.40.2” frameRate=“30”
  startWithSAP=“1” segmentAlignment=“true”>
  <Representation id=“segment_4k_quality1”
  mimeType=“video/mp4”
codecs=“avc1.640028” width=“3840” height=“2160”
  bandwidth=“6000000”>
  <SegmentTemplate
  media=“segment_4k_quality1_$Number$.m4s”
initialization=“segment_4k_quality 1_init.mp4” duration=“2000”
  startNumber=“1” timescale=“1000”/>
  </Representation>
  <Representation id=“segment_4k_quality2”
  mimeType=“video/mp4”
codecs=“avc1.640028” width=“3840” height=“2160”
  bandwidth=“8000000”>
  <SegmentTemplate
  media=“segment_4k_quality2_$Number$.m4s”
initialization=“segment_4k_quality2_init.mp4” duration=“2000”
  startNumber=“1” timescale=“1000”/>
  </Representation>
  <Representation id=“segment_4k_quality3”
  mimeType=“video/mp4”
codecs=“avc1.640028” width=“3840” height=“2160”
  bandwidth=“10000000”>
  <SegmentTemplate media=“segment_4k_quality3_$Number$.m4s”
initialization=“segment_4k_quality3_init.mp4” duration=“2000”
  startNumber=“1” timescale=“1000”/>
  </Representation>
  .
  .
  .
  </AdaptationSet>
  <!-- Adaptation Set for English Audio -->
  <AdaptationSet id=“as4”
  contentType=“audio” mimeType=“audio/mp4”
codecs=“mp4a.40.2” lang=“en” segmentAlignment=“true”
  startWithSAP=“1”>
  <SegmentTemplate media=“audio_segment_$Number$.m4s”
initialization=“audio_init.m4s” duration=“2” startNumber=“1”
  timescale=“1000”/>
  <Representation id=“10” bandwidth=“192000”
  audioSamplingRate=“48000” />
  <Representation id=“r11” bandwidth=“128000”
  audioSamplingRate=“44100” />
  <Representation id=“r12” bandwidth=“96000”
  audioSamplingRate=“44100” />
  </AdaptationSet>
  </Period>
  </MPD>
```

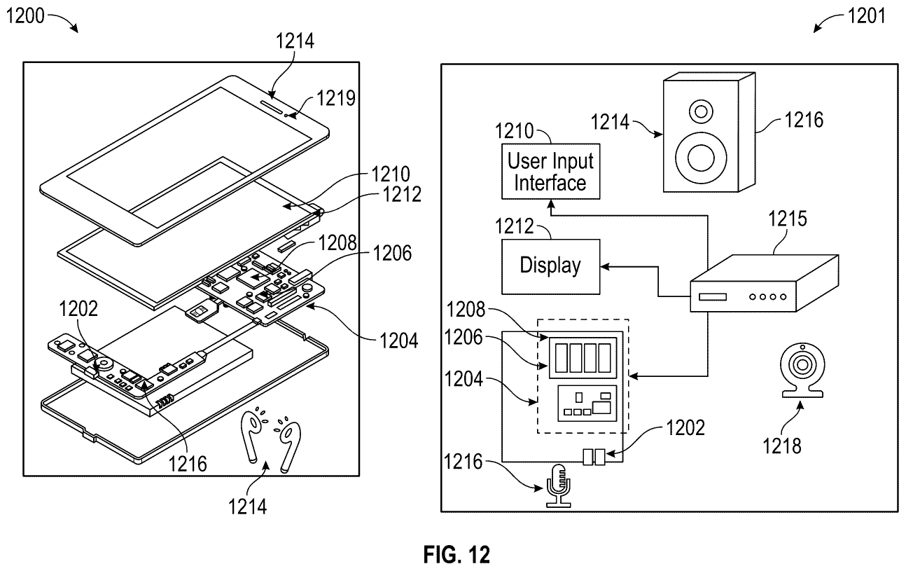

FIGS. 12-13 describe illustrative devices, systems, servers, and related hardware for extending selectable object capability to a captured image, in accordance with some embodiments of the present disclosure. In some embodiments, any suitable combination of the components of FIGS. 6-7 may be employed to perform the techniques described in FIGS. 1-11 and 14-15.

FIGS. 12-13 show illustrative devices, systems, servers, and related hardware for modifying content based on a detected environment, in accordance with some embodiments of this disclosure. FIG. 12 shows generalized embodiments of illustrative computing devices 1200 and 1201, which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR head-mounted display (HMD); a VR HMD; or any other suitable computing device; or any combination thereof. In another example, computing device 1201 may be a user television equipment system or device. In some embodiments, computing devices 1200 and 1201 may correspond to, e.g., one or more of first device 102.

User television equipment device 1201 may include set-top box 1215. Set-top box 1215 may be communicatively connected to microphone 1216, Audio output equipment (e.g., speaker or headphones 1214), and display 1212. In some embodiments, microphone 1216 may receive audio corresponding to a voice of a user providing input. In some embodiments, display 1212 may be a television display or a computer display. In some embodiments, set-top box 1215 may be communicatively connected to user input interface 1210. In some embodiments, user input interface 1210 may be a remote control device. Set-top box 1215 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 12. In some embodiments, computing device 1200 may comprise any suitable number of sensors (e.g., gyroscope or gyrometer, or accelerometer, etc.), and/or a GPS module (e.g., in communication with one or more servers and/or cell towers and/or satellites) to ascertain a location of computing device 1200. In some embodiments, computing device 1200 comprises a rechargeable battery that is configured to provide power to the components of the device.

Each one of computing device 1200 and computing device 1201 may receive content and data via input/output (I/O) path 1202. I/O path 1202 may provide content (e.g., broadcast programming, on-demand programming, Internet content, content available over a local area network (LAN) or wide area network (WAN), and/or other content) and data to control circuitry 1204, which may comprise processing circuitry 1206 and storage 1208. Control circuitry 1204 may be used to send and receive commands, requests, and other suitable data using I/O path 1202, which may comprise I/O circuitry. I/O path 1202 may connect control circuitry 1204 (and specifically processing circuitry 1206) to one or more communications paths (described below). I/O functions may be provided by one or more of these communications paths, but are shown as a single path in FIG. 12 to avoid overcomplicating the drawing. While set-top box 1215 is shown in FIG. 12 for illustration, any suitable computing device having processing circuitry, control circuitry, and storage may be used in accordance with the present disclosure. For example, set-top box 1215 may be replaced by, or complemented by, a personal computer (e.g., a notebook, a laptop, a desktop), a smartphone (e.g., computing device 1200), an XR device; a tablet; a network-based server hosting a user-accessible client device; a non-user-owned device; any other suitable device; or any combination thereof.

Control circuitry 1204 may be based on any suitable control circuitry such as processing circuitry 1206. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1204 executes instructions for the output control system 100 stored in memory (e.g., storage 1208). Specifically, control circuitry 1204 may be instructed by the output control system 100 to perform the functions discussed above and below. In some implementations, processing or actions performed by control circuitry 1204 may be based on instructions received from the output control system 100.

In client/server-based embodiments, control circuitry 1204 may include communications circuitry suitable for communicating with a server or other networks or servers. The output control system 100 may be a stand-alone application implemented on a device or a server. The output control system 100 may be implemented as software or a set of executable instructions. The instructions for performing any of the embodiments discussed herein of the output control system 100 may be encoded on non-transitory computer-readable media (e.g., a hard drive, random-access memory on a DRAM integrated circuit, read-only memory on a BLU-RAY disk, etc.). For example, in FIGS. 1A-1B, the instructions may be stored in storage 1208, and executed by control circuitry 1204 of a device 1200.

In some embodiments, the output control system 100 may be a client/server application where only the client application resides on device 1200 (e.g., device 1204), and a server application resides on an external server (e.g., server 1204). For example, the output control system 100 may be implemented partially as a client application on control circuitry 1204 of device 1200 and partially on server 1204 as a server application running on control circuitry 1313. Server 1304 may be a part of a local area network with one or more of devices 1200, 1201 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 1304 and/or an edge computing device), referred to as “the cloud.”

Device 1200 may be a cloud client that relies on the cloud computing capabilities from server 1304 to determine whether processing (e.g., at least a portion of virtual background processing and/or at least a portion of other processing tasks) should be offloaded from the mobile device, and facilitate such offloading. When executed by control circuitry of server 1304, the output control system 100 may instruct control circuitry 1311 to perform processing tasks for the client device and facilitate the generation of encoding data. The client application may instruct control circuitry 1204 to determine whether processing should be offloaded.

Control circuitry 1204 may include communications circuitry suitable for communicating with a server, edge computing systems and devices, a table or database server, or other networks or servers The instructions for carrying out the above mentioned functionality may be stored on a server (which is described in more detail in connection with FIG. 13. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 13). In addition, communications circuitry may include circuitry that enables peer-to-peer communication of computing devices, or communication of computing devices in locations remote from each other (described in more detail below).

Memory may be an electronic storage device provided as storage 1208 that is part of control circuitry 1204. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1208 may be used to store various types of content described herein as well as the output control system 100 data described above. Nonvolatile memory may also be used (e.g., to launch a boot-up routine and other instructions). Cloud-based storage, described in more detail in relation to FIG. 13, may be used to supplement storage 1208 or instead of storage 1208.

Control circuitry 1204 may include video generating circuitry and tuning circuitry, such as one or more analog tuners, or HEVC decoders or any other suitable digital decoding circuitry, high-definition tuners, or any other suitable tuning or video circuits or combinations of such circuits. Encoding circuitry (e.g., for converting over-the-air, analog, or digital signals to SHVC or any other suitable signals for storage) may also be provided. Control circuitry 1204 may also include scaler circuitry for upconverting and down converting content into the preferred output format of computing device 1200. Control circuitry 1204 may also include digital-to-analog converter circuitry and analog-to-digital converter circuitry for converting between digital and analog signals. The tuning and encoding circuitry may be used by computing device 1200, 1201 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1208 is provided as a separate device from computing device 1200, the tuning and encoding circuitry (including multiple tuners) may be associated with storage 1208.

Control circuitry 1204 may receive instruction from a user by way of user input interface 1210. User input interface 1210 may be any suitable user interface, such as a remote control, mouse, trackball, keypad, keyboard, touch screen, touchpad, stylus input, joystick, voice recognition interface, or other user input interfaces. Display 1212 may be provided as a stand-alone device or integrated with other elements of each one of computing device 1200 and computing device 1201. For example, display 1212 may be a touchscreen or touch-sensitive display. In such circumstances, user input interface 1210 may be integrated with or combined with display 1212. In some embodiments, user input interface 1210 includes a remote-control device having one or more microphones, buttons, keypads, any other components configured to receive user input or combinations thereof. For example, user input interface 1210 may include a handheld remote-control device having an alphanumeric keypad and option buttons. In a further example, user input interface 1210 may include a handheld remote-control device having a microphone and control circuitry configured to receive and identify voice commands and transmit information to set-top box 1215.

Audio output equipment 1214 may be integrated with or combined with display 1212. Display 1212 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1212. Audio output equipment 1214 may be provided as integrated with other elements of each one of computing device 1200 and computing device 1201 or may be stand-alone units. An audio component of videos and other content displayed on display 1212 may be played through speakers (or headphones) of audio output equipment 1214. In some embodiments, audio may be distributed to a receiver (not shown), which processes and outputs the audio via speakers of audio output equipment 1214. In some embodiments, for example, control circuitry 1204 is configured to provide audio cues to a user, or other audio feedback to a user, using speakers of audio output equipment 1214. There may be a separate microphone 1216 or audio output equipment 1214 may include a microphone configured to receive audio input such as voice commands or speech. For example, a user may speak letters or words or terms or numbers that are received by the microphone and converted to text by control circuitry 1204. In a further example, a user may voice commands that are received by a microphone and recognized by control circuitry 1204. Camera 1218 may be any suitable video camera integrated with the equipment or externally connected. Camera 1218 may be a digital camera comprising a charge-coupled device (CCD) and/or a complementary metal-oxide semiconductor (CMOS) image sensor. Camera 1218 may be an analog camera that converts to digital images via a video card.

The output control system 100 may be implemented using any suitable architecture. For example, it may be a stand-alone application wholly-implemented on each one of computing device 1200 and computing device 1201. In such an approach, instructions of the application may be stored locally (e.g., in storage 1208), and data for use by the application is downloaded on a periodic basis (e.g., from an out-of-band feed, from an Internet resource, or using another suitable approach). Control circuitry 1204 may retrieve instructions of the application from storage 1208 and process the instructions to provide video conferencing functionality and generate any of the displays discussed herein. Based on the processed instructions, control circuitry 1204 may determine what action to perform when input is received from user input interface 1210. For example, movement of a cursor on a display up/down may be indicated by the processed instructions when user input interface 1210 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1204 may allow a user to provide user profile information or may automatically compile user profile information. For example, control circuitry 1204 may access and monitor network data, video data, audio data, processing data, participation data from a conference participant profile. Control circuitry 1204 may obtain all or part of other user profiles that are related to a particular user (e.g., via social media networks), and/or obtain information about the user from other sources that control circuitry 1204 may access. As a result, a user can be provided with a unified experience across the user's different devices.

In some embodiments, the output control system 100 is or comprises a client/server-based application. Data for use by a thick or thin client implemented on each one of computing device 1200 and computing device 1201 may be retrieved on-demand by issuing requests to a server remote to each one of computing device 1200 and computing device 1201. For example, the remote server may store the instructions for the application in a storage device. The remote server may process the stored instructions using circuitry (e.g., control circuitry 1204) and generate the displays discussed above and below. The client device may receive the displays generated by the remote server and may display the content of the displays locally on computing device 1200. This way, the processing of the instructions is performed remotely by the server while the resulting displays (e.g., that may include text, a keyboard, or other visuals) are provided locally on computing device 1200. Computing device 1200 may receive inputs from the user via input interface 1210 and transmit those inputs to the remote server for processing and generating the corresponding displays. For example, computing device 1200 may transmit a communication to the remote server indicating that an up/down button was selected via input interface 210. The remote server may process instructions in accordance with that input and generate a display of the application corresponding to the input (e.g., a display that moves a cursor up/down). The generated display is then transmitted to computing device 1200 for presentation to the user.

In some embodiments, the output control system 100 may be downloaded and interpreted or otherwise run by an interpreter or virtual machine (run by control circuitry 1204). In some embodiments, the output control system 100 may be encoded in the ETV Binary Interchange Format (EBIF), received by control circuitry 1204 as part of a suitable feed, and interpreted by a user agent running on control circuitry 1204. For example, the output control system 100 may be an EBIF application. In some embodiments, the output control system 100 may be defined by a series of JAVA-based files that are received and run by a local virtual machine or other suitable middleware executed by control circuitry 1204. In some of such embodiments (e.g., those employing H.265, SHVC or any other suitable digital media encoding schemes), the output control system 100 may be, for example, encoded and transmitted in using an SHVC with the SHVC audio and video packets of a program.

FIG. 13 is a diagram of an illustrative system 1300 for enabling user controlled extended reality, in accordance with some embodiments of this disclosure. Computing devices 1307, 1308, 1310 (which may correspond to, e.g., computing device 1300 or 1301) may be coupled to communication network 1309. Communication network 1309 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1309) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 13 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 602-11x, etc.), or other short-range communication via wired or wireless paths. The computing devices may also communicate with each other directly through an indirect path via communication network 1309.

System 1300 may comprise media content source 1302, one or more servers 1304, and/or one or more edge computing devices. In some embodiments, the output control system 100 may be executed at one or more of control circuitry 1313 of server 1304 (and/or control circuitry of computing devices 1307, 1308, 1310 and/or control circuitry of one or more edge computing devices). In some embodiments, the media content source and/or server 1304 may be configured to host or otherwise facilitate video communication sessions between computing devices 1307, 1308, 1310 and/or any other suitable computing devices, and/or host or otherwise be in communication (e.g., over network 1309) with one or more social network services.

In some embodiments, server 1304 may include control circuitry 1313 and storage 1314 (e.g., RAM, ROM, Hard Disk, Removable Disk, etc.). Storage 1314 may store one or more databases. Server 1304 may also include an input/output path 1312. I/O path 1312 may provide video conferencing data, device information, or other data, over a local area network (LAN) or wide area network (WAN), and/or other content and data to control circuitry 1313, which may include processing circuitry, and storage 1314. Control circuitry 1313 may be used to send and receive commands, requests, and other suitable data using I/O path 1312, which may comprise I/O circuitry. I/O path 1312 may connect control circuitry 1313 (and specifically control circuitry) to one or more communications paths.

Control circuitry 1313 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1313 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1313 executes instructions for an emulation system application stored in memory (e.g., the storage 1314). Memory may be an electronic storage device provided as storage 1314 that is part of control circuitry 1313.

In some embodiments, server 1304 may be included in a CDN, which may include origin servers, data centers, central servers, and/or edge servers, and/or any other suitable components. Computing devices 1307, 1308, 1310 may comprise one or more decoders, which may comprise any suitable combination of hardware and/or software configured to convert data in a coded form to a form that is usable as video signals and/or audio signals or any other suitable type of data signal, or any combination thereof. The encoder may comprise any suitable combination of hardware and/or software configured to process data to reduce storage space required to store the data and/or bandwidth required to transmit the image data, while minimizing the impact of the encoding on the quality of the video or one or more images. The encoder and/or decoder may utilize any suitable algorithms and/or compression standards and/or codecs. In some embodiments, the encoder and/or decoder may be a virtual machine that may reside on one or more physical servers that may or may not have specialized hardware, and/or a cloud service may determine how many of these virtual machines to use based on established thresholds. In some embodiments, separate audio and video encoders and/or decoders may be employed.

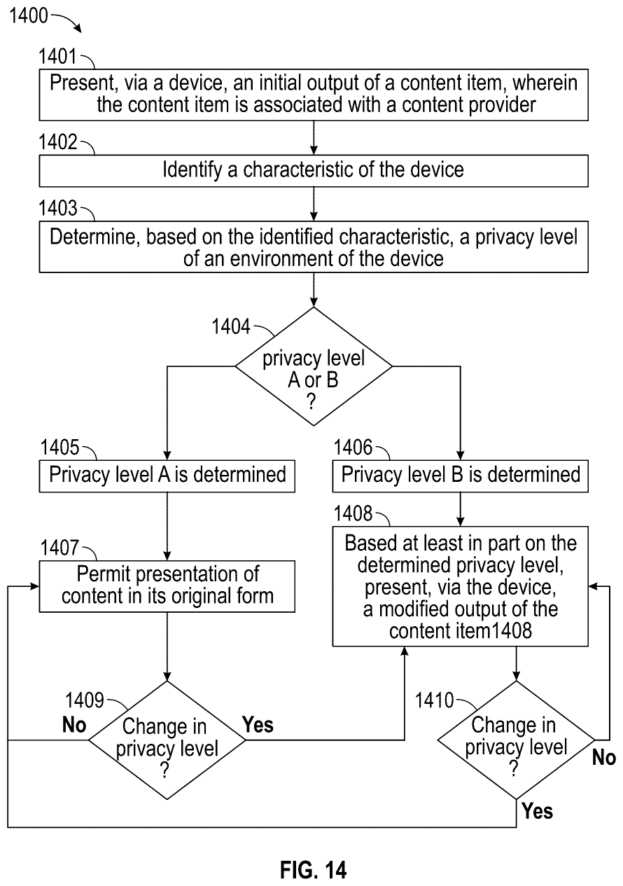

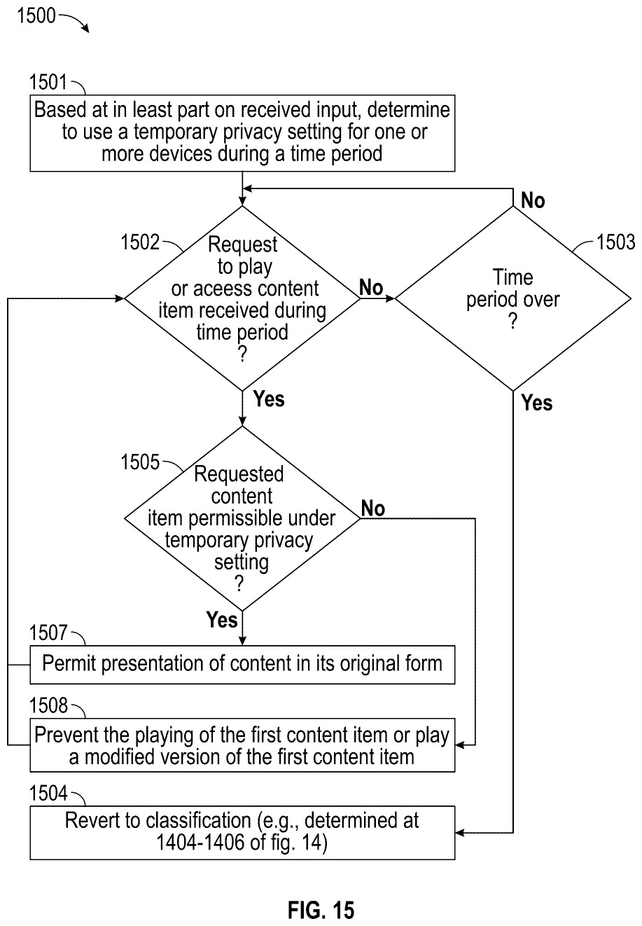

FIG. 14 shows an illustrative flowcharts of a process for modifying content based on a display environment, in accordance with some embodiments of this disclosure. In various embodiments, the individual steps of process 1400 may be implemented by one or more components of the devices, methods, and systems of FIGS. 1-13 and 15 and may be performed in combination with any of the other processes and aspects described herein. Although the present disclosure may describe certain steps of processes 1400 (and of other processes described herein) as being implemented by certain components of the devices, methods, and systems of FIGS. 1-13 and 15, this is for purposes of illustration only, and it should be understood that other components of the devices, methods, and systems of FIGS. 1-13 and 15 may implement those steps instead.

In process 1400, at step 1401, control circuitry (e.g., control circuitry 1204 of computing device 1200 of FIG. 12 and/or control circuitry 1313 of server 1304 of FIG. 13) may present, via a device (e.g., second device 104 of FIG. 1A) an initial output of a content item (e.g., a video, such as a movie or television show, or audio, such as music or a podcast). Such content item may be associated with a content provider (e.g., a streaming service). For example, such device may be a second device to which content is being cast by a first device (e.g., first device 102 of FIG. 1A). In some embodiments, a request to cast a media asset to the device (e.g., second device 104 of FIG. 1A) may cause processing to proceed to 1402. In some embodiments, the initial output of the content item being presented at the device (e.g., second device 104 of FIG. 1A) may be an introductory scene or credits, or may be a displayed indication regarding the attempt to cast the media asset to the second device.

At 1402, the control circuitry may identify a characteristic of the device (e.g., second device 104 of FIG. 1A). The characteristic of the device may be, for example, a type of Wi-Fi connection connected to the device, the type of audio output (e.g., headphones, speakers, or low volume), the number of unfamiliar devices surrounding the device, ambient noise level, extent of movement surrounding the device, or any other suitable data, or any suitable combination thereof. In some embodiments, 1402 may be performed prior to 1401, e.g., periodically, or based at least in part on 1401 being performed.

At 1403, the control circuitry may determine, based on the identified characteristic of step 1402, a privacy level of an environment (e.g., environment 101 of FIG. 1A) of the device (e.g., second device 104 of FIG. 1A). For example, if step 1402 identifies that many unfamiliar Bluetooth devices (e.g., a number of devices exceeding a threshold) surround the device, this may weigh in favor of (or cause control circuitry to determine) that the device is in a public setting. As another example, if step 1402 recognizes that the device is connected to its home internet connection, the control circuitry may determine that the device is at home and in a private setting.

If the control circuitry determines, at 1404 and 1405, that the device has a first privacy level, privacy level A (e.g., private), the control circuitry may permit the content item indicated at 1401 to be presented in its original, unmodified form (e.g., as shown in FIG. 1A). On the other hand, if the control circuitry determines, at 1404 and 1406, that the device has a second privacy level, privacy level B (e.g., public), the control circuitry may, at 1407, based at least in part on the determined privacy level present, via the device, a modified output of the content item (e.g., scene 2B instead of scene 2A, as shown in FIGS. 1A-1B). For example, if the control circuitry determines that the privacy level is public, the control circuitry will cause presentation of an altered version of the content item in place of that of the original content item. For example, due to the public setting, the control circuitry may prevent presentation of graphic scene or lewd language. In some embodiments, the control circuitry replaces such output with more suitable content. In some embodiments, the control circuitry skips the inappropriate content. In some embodiments, the control circuitry displays an idle screen in place of the inappropriate content. It should be appreciated that, while FIG. 14 depicts privacy level A or B, a privacy level classification may be selected from any suitable number of privacy level classifications. For example, a semi-private classification may be determined for a particular environment, as described herein. For example, a semi-private classification for the environment may because the content to be presented with less modifications to output of content than is performed for a public environment, but more modifications to output of content than is performed for a private environment.

In some embodiments, at 1409 and 1410, the control circuitry may determine whether a privacy level of the environment has changed. For example, if, while the original version of the content item is being cast to the device at 1407, one or more of characteristics identified at 1402 lead to a determination that the environment is now a public environment, processing may proceed to 1408. On the other hand, if, while the modified version of the content item is being cast to the device at 1407, one or more of characteristics identified at 1402 lead to a determination that the environment is now a private environment, processing may proceed to 1407. If there is no change in privacy level at 1409 and 1410, processing may revert to 1407 and 1408, respectively, to continue to present the original content item or the modified content item, respectively.

FIG. 15 shows illustrative flowcharts of processes for modifying content based on a display environment, in accordance with some embodiments of this disclosure. In various embodiments, the individual steps of processes 1500 may be implemented by one or more components of the devices, methods, and systems of FIGS. 1-14 and may be performed in combination with any of the other processes and aspects described herein. Although the present disclosure may describe certain steps of processes 1400 (and of other processes described herein) as being implemented by certain components of the devices, methods, and systems of FIGS. 1-14, this is for purposes of illustration only, and it should be understood that other components of the devices, methods, and systems of FIGS. 1-13 and 15 may implement those steps instead.

In process 1500, at step 1501 control circuitry (e.g., control circuitry 1204 of computing device 1200 of FIG. 12 and/or control circuitry 1313 of server 1304 of FIG. 13) may, based at least in part on received input determine to use a temporary privacy setting for one or more devices during a time period. For example, the received input may be explicit, “Please only allow content appropriate for kids during the children's birthday party tomorrow from 1 PM to 4 PM,” or based on other data, e.g., identifying calendar data or a social media post indicative of an occurrence of such an event. As another example, if the party is occurring at a private residence which generally would be considered a private environment, as described herein, such inputs and/or other inputs (e.g., detection of over a threshold number of children's voice, a larger than usual number of unfamiliar Bluetooth devices surrounding a device, and/or any other suitable data) may be the basis for temporarily classifying such residence as a public environment (e.g., during the children's party).

During the time period, at 1502, the control circuitry may determine whether a request has been received, for example, from a device connected to a network (e.g., LAN or otherwise communicating via Bluetooth with other devices) at the location, e.g., first device 902 of FIG. 9, second device 902 (e.g., an attempt to cast from device 904) of FIG. 9, or smart speaker 905 of FIG. 9 in the environment associated with the time period (e.g., children's birthday party), to play or access a first content item, such as, for example, a movie, a television show, an image, or music, on the one or more devices. In some embodiments, certain devices (e.g., device in parent's room, away from where the party is occurring, or a parent's device) may not be subject to any of the content restrictions of the temporary privacy setting.

If no request is received, processing may proceed to 1503, where the control circuitry may determine whether the time period has ended. For example, time period may be a preset time period, for example during a scheduled event, and the control circuitry may determine whether or the end of the time period may be detected based on a decrease in certain activity, e.g., less voices or device detected, such as under a threshold amount. If the time period associated with the event is determined to be over, processing may proceed to 1504, where a classification for the environment may be based on the determination at 1404-1406 of FIG. 14.

At 1505, the control circuitry may determine whether the requested content item is permissible to be displayed in the environment (e.g., environment 901 of FIG. 9) under the temporary privacy setting (e.g., private, or only permitting presentation of content appropriate for children). If so, processing may proceed to 1507, where the content may be presented in its original form. Otherwise, processing may proceed to 1508, where the control circuitry may prevent the playing of the first content item or play a modified version of the first content item (e.g., removing or modifying objectionable scenes). In some embodiments, the control circuitry may provide a recommendation of content that is permissible under the temporary privacy setting, to be played or accessed instead of the objectionable content item. In some embodiments, 1507 and/or 1508 may include continuously evaluating whether a current or upcoming scene or segment is suitable under the temporary privacy setting, and taking appropriate action is such scene or segment is determined not to be suitable.

The processes discussed above and below are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any some embodiments, may be applied to any other embodiment herein, and flowcharts or examples relating to some embodiments, may be combined with any other embodiment in a suitable manner, done in different orders, or done in parallel. In addition, the systems, methods, apparatuses, and computer-readable media described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A computer-implemented method, comprising:
presenting, via a device, an initial output of a content item, wherein the content item is associated with a content provider;
identifying a characteristic of the device;
determining, based on the identified characteristic, a privacy level of an environment of the device; and
based at least in part on the determined privacy level, presenting, via the device, a modified output of the content item.

2. The method of claim 1, wherein the device is a first device, wherein a second device casts or streams the initial output of the content item to the first device, and wherein the second device is in communication with the content provider to receive the modified output of the content item and provide the modified output of the content item to the first device.

3. The method of claim 2, wherein an indication of the determined privacy level is provided for display on the second device, prior to the second device casting or streaming the initial output of the content item to the first device.

4. The method of claim 2, wherein an option to stream or cast the content to the first device is provided for display on the second device based at least in part on digital rights associated with the content item.

5. The method of claim 2, wherein a manifest file associated with the content item is provided by a server to the second device, and wherein presenting, via the first device, the modified output of the content item is further based at least in part on the server:
altering at least a portion of the manifest file based at least in part on the privacy level of the environment; and
providing the altered manifest file to the first device.

6. The method of claim 1, further comprising:
analyzing at least one segment of the content item,
wherein presenting the modified output of the content item is further based on the analyzing.

7. The method of claim 1, wherein determining the privacy level comprises determining whether the environment of the device is a public environment or a private environment, and presenting the modified output of the content item is based at least in part on determining that the device is in a public environment.

8. The method of claim 1, wherein a manifest file is provided for segments of the content item when the environment of the device is a private environment, and based at least in part on determining that the device is in a public environment, the manifest is updated to enable the modifying of the output of the content item.

9. The method of claim 1, wherein the characteristic is a number of devices in the environment determined to have previously been paired with the device, and wherein determining that the device is in a public environment is based at least in part on determining that the number of devices exceeds a threshold.

10. The method of claim 1, wherein the device is connected to a Wi-Fi network, and wherein the characteristic is based on a Wi-Fi network type of the Wi-Fi network, and wherein determining that the device is in a public environment is based at least in part on the Wi-Fi network type being indicative of a public network.

11. The method of claim 1, wherein determining that the device is in a public environment is based at least in part on determining that an ambient noise level in the environment exceeds a threshold.

12. The method of claim 1, wherein determining that the device is in a public environment is based at least in part on determining that a number of inputs received at the device over a period of time via a remote control is fewer than a threshold.

13. The method of claim 1, wherein:
when presenting the initial output of the content item, a modified version of a future segment of the content item is downloaded while the device is connected to a Wi-Fi network; and
the determining, based on the identified characteristic, the privacy level of the environment of the device occurs while the device is not connected to the Wi-Fi network; and
the device is configured to display the modified output of the content item using the modified version of the future segment.

14. A system comprising:
control circuitry configured to:
present, via a device, an initial output of a content item, wherein the content item is associated with a content provider;
identify a characteristic of the device;
determine, based on the identified characteristic, a privacy level of an environment of the device; and
based at least in part on the determined privacy level, present, via the device, a modified output of the content item.

15. The system of claim 14, wherein the device is a first device, wherein a second device casts or streams the initial output of the content item to the first device, and wherein the second device is in communication with the content provider to receive the modified output of the content item and provide the modified output of the content item to the first device.

16. The system of claim 15, wherein an indication of the determined privacy level is provided for display on the second device, prior to the second device casting or streaming the initial output of the content item to the first device.

17. The system of claim 15, wherein an option to stream or cast the content to the first device is provided for display on the second device based at least in part on digital rights associated with the content item.

18. The system of claim 15, wherein a manifest file associated with the content item is provided by a server to the second device, and wherein presenting, via the first device, the modified output of the content item is further based at least in part on the server:
altering at least a portion of the manifest file based at least in part on the privacy level of the environment; and
providing the altered manifest file to the first device.

19. The system of claim 14, wherein the control circuitry is further configured to:
analyze at least one segment of the content item; and
present the modified output of the content item is further based on the analyzing.

20. The system of claim 14, wherein the control circuitry is further configured to determine the privacy level by determining whether the environment of the device is a public environment or a private environment, and presenting the modified output of the content item is based at least in part on determining that the device is in a public environment.

21-65. (canceled)
